(19) United States
(12) Patent Application Publication
(10) Pub. No.: US 2024/0189910 A1
(43) Pub. Date: Jun. 13, 2024

(54) IN-SITU WELD POOL SPECTRUM RADIATION PROCESS CHARACTERIZATION

(71) Applicant: Divergent Technologies, Inc., Los Angeles, CA (US)

(72) Inventors: Gordon TAJIRI, Los Angeles, CA (US); Michael Thomas KENWORTHY, Rancho Palos Verdes, CA (US); Mu Li, San Pedro, CA (US); Chan Cheong Pun, Costa Mesa, CA (US)

(21) Appl. No.: 18/487,020

(22) Filed: Oct. 13, 2023

Related U.S. Application Data
(60) Provisional application No. 63/379,554, filed on Oct. 14, 2022.
(60) Provisional application No. 63/448,641, filed on Feb. 27, 2023.

(51) Int. Cl. B22F 10/85; B22F 10/28; B22F 10/36; B22F 10/80; B22F 12/41; B22F 12/49; B22F 12/50; B22F 12/90; B33Y 10/00; B33Y 30/00; B33Y 50/00; B33Y 50/02

(52) U.S. Cl. CPC B22F 10/85; B22F 10/28; B22F 10/36; B22F 10/80; B22F 12/41; B22F 12/49; B22F 12/50; B22F 12/90; B33Y 10/00; B33Y 30/00; B33Y 50/00; B33Y 50/02; B22F 2998/10

(57) ABSTRACT

A printer and methods for additive manufacturing a build piece may include a camera and an optical spectrometer obtaining spectral information and optical information from a region of melted material to determine a defect condition based on an evaluation of processed spectral or optical information. A processor or a computer may process the obtained and optical information and determine a defect condition during the additively manufacturing process. The obtained spectral and optical information may be of the region of the melted material, a melt pool and a mushy zone. The printer and method may include a controller configured to modify a process parameter to shape the weld pool to obtain a desired effective absorptivity of a portion of the weld pool, e.g., to increase the effective absorptivity relative to an absorptivity of a surface of the powder or material deposited by the depositor and to maintain an acceptable temperature of the weld pool during the additively manufacturing process.

### CROSS-REFERENCE TO RELATED APPLICATIONS

This application claims the benefit of, and right to priority to, U.S. Provisional Application No. 63/379,554 filed on Oct. 14, 2022 and U.S. Provisional Application No. 63/448,641 filed on Feb. 27, 2023, both entitled “In-Situ Melt Pool Broad Spectrum Radiation Process Characterization and Monitoring for Transient Elemental State and Composition Changes”, the entirety of which are incorporated by reference as if fully set forth herein.

### BACKGROUND

### Field

The present disclosure relates generally to additive manufacturing, and more particularly, to obtaining spectral and optical information and determining a defect condition during additive manufacturing of a build piece based on an evaluation of processed spectral information and/or optical information.

### Background

Additive manufacturing (AM) systems, apparatuses and methods can produce metal or non-metallic structures (referred to as build pieces) with geometrically complex shapes, including some shapes that are difficult or impossible to create with conventional manufacturing processes. AM techniques are used to create build pieces layer-by-layer, i.e., slice-by-slice. Each layer or slice can be formed by a process of depositing a layer of material such as a metallic or non-metallic powder and melting and/or cooling areas or regions of the material that coincide with the cross-section of the build piece in the layer. The process can be repeated to form the next slice of the build piece, and so on. Because each layer is deposited on the previous layer, AM can be likened to forming a structure slice-by-slice and allows for the formation of structures that were previously not possible to be formed by traditional machining (i.e., subtractive manufacturing) technologies.

Build pieces are expected to conform to desired print parameters, such as a desired shape, a desired material density, desired mechanical characteristics, etc. However, build pieces often do not exactly conform to the desired characteristics. In some cases, the lack of conformity can require post-processing techniques, such as sanding, filing, etc., to correct the shape of the build piece, which can increase production costs. In some cases, the build piece cannot be repaired or fixed and must be discarded, which can lower yield and significantly increase production costs.

### SUMMARY

In this disclosure, it is recognized that the detection of in-process physical properties and states such as transient elemental state and temperature changes during additive manufacturing processes, such as Direct Metal Laser Melting (DMLM), Powder Bed Fusion (PBF), Selective Laser Melting (SLM), etc., can be used to determine a defect condition, which is a condition that may lead to a defect or is itself a defect. For example, keyholing is a condition that can occur when a laser is scanned across a powder bed, in which gasses from the melting process can create a deep cavity in the melt pool. Keyholing can lead to a defect in the build piece caused by bubbles of the gas becoming trapped in the solidified material. Keyholing can be a defect condition that may be detected. Likewise the trapped bubbles themselves can be a defect condition that may be detected. If a defect condition is detected, the process may, for example, modify a process parameter to reduce or eliminate the defect condition. Several aspects of the apparatuses and methods in AM will be disclosed more fully hereinafter. The following summary of one or more aspects of the disclosure is presented to provide a basic understanding of such aspects. This summary is not an extensive overview of all contemplated aspects and is intended to neither identify key or critical elements nor delineate the scope of any or all aspects. Its purpose is to present some concepts of one or more aspects in a simplified form as a prelude to the more detailed description that is presented later.

In various embodiments disclosed herein are apparatuses and methods in additive manufacturing. In one aspect, the method includes applying an energy beam to melt a region of material to form a melt pool that cools to form a portion of a build piece, obtaining spectral information from the region, processing the spectral information to obtain processed spectral information, obtaining an evaluation based on the processed spectral information, and determining a defect condition of the additive manufacturing based on the evaluation.

In one or more embodiments, the method includes depositing the material onto a build plate and the material includes a powder.

In one or more embodiments, the method includes obtaining optical information from the region, processing the optical information to obtain processed optical information, and the evaluation is further based on the processed optical information.

In one or more embodiments, the method of obtaining the optical information includes controlling a camera to perform optical imaging at a first port with a first field of view of the region of the material, and the method of obtaining the spectral information includes controlling an optical spectrometer to perform optical spectroscopy at a second port with a second field of view of the region of the material. The first field of view and the second field of view may be the same or may be different.

In one or more embodiments, the method of obtaining the spectral information includes receiving a backscattered radiation from the region.

In one or more embodiments, the method of obtaining the spectral information further includes filtering the backscattered radiation to obtain filtered backscattered radiation.

In one or more embodiments, the method includes shielding the optical spectrometer from reflected power of a laser.

In one or more embodiments, the weld pool includes a mushy zone, obtaining mushy zone information from the region, processing the mushy zone information, and the evaluation is further based on the mushy zone information.

In one or more embodiments, the mushy zone information includes at least temperature information, temperature gradient, solidification rate, or shape information.

In one or more embodiments, the mushy zone includes a relaxation region and a vulnerable region, and the mushy zone information includes a ratio of a length of the relaxation region and a length of the vulnerable region.

In one or more embodiments, the evaluation includes a characteristic of the weld pool and the characteristic of the weld pool includes keyhole information or at least a dimension, a shape, a temperature or a temperature gradient. The shape includes a depth, a length, a width, a perimeter, an area or a volume.

In one or more embodiments, the method includes modifying a process parameter of the additive manufacturing based on the defect condition.

In one or more embodiments, the method includes adjusting the process parameter to maintain an acceptable temperature of the weld pool during additively manufacturing of the build piece.

In one or more embodiments, the energy beam includes a laser beam, and the process parameter includes at least laser power, hatch spacing, scan speed, a beam profile of the laser beam, a beam size of the laser beam, or a beam shape of the laser beam.

In one or more embodiments, adjusting the laser power and at least adjusting the hatch spacing, the scan speed, the beam profile or the beam shape.

In one or more embodiments, the spectral information includes at least a spectral profile or spectral intensity.

In one or more embodiments, the method includes determining at least a temperature profile or a physical state of the weld pool or the mushy zone from the spectral profile or the spectral intensity.

In one or more embodiments, the processed spectral information is a change in a value of the spectral intensity during additively manufacturing of the build piece. The spectral intensity may include a hydrogen spectral intensity, a water vapor spectral intensity, or a magnesium spectral intensity.

In one or more embodiments, the method of obtaining the spectral information includes performing optical spectroscopy on backscattered radiation from the region.

In one or more embodiments, the method includes applying an energy beam to melt a material to form a weld pool that cools to form a portion of a build piece, obtaining spectral information from the weld pool, and adjusting, based on the spectral information, a process parameter to shape the weld pool to obtain a desired effective absorptivity of a portion of the weld pool, e.g., to increase the effective absorptivity relative to an absorptivity of a surface of the powder or material deposited by the depositor.

In one or more embodiments, the spectral information includes at least intensity of reflected laser light, a depth, a length, a width, a perimeter, an area or a volume.

In one or more embodiments, the method includes applying an energy beam to melt a material to form a weld pool that cools to form a portion of a build piece, the weld pool includes a mushy zone, obtaining mushy zone information of the mushy zone, and modifying a process parameter based on the mushy zone information.

In one or more embodiments, the method includes applying an energy beam to melt a material to form a weld pool that cools to form a portion of a build piece, the weld pool includes a mushy zone, obtaining mushy zone information of the mushy zone, processing the mushy zone information to obtain processed mushy zone information, obtaining an evaluation based on the processed mushy zone information, and determining a defect condition of the additive manufacturing based on the evaluation.

In one or more embodiments, the printer includes a depositor configured to deposit material, an energy beam source configured to generate an energy beam, the energy beam is configured to melt a region of the material to form a weld pool that cools to form a portion of a build piece, a first device configured to obtain spectral information from the region, and a processor or a computer in communication with the first device and configured to process the spectral information to obtain processed spectral information, perform an evaluation based on the processed spectral information, and determine a defect condition of the additive manufacturing based on the evaluation.

In one or more embodiments, the depositor is configured to deposit the material onto a build plate, the material includes a powder, and the printer includes a deflector is configured to apply the energy beam to the region of the material.

In one or more embodiments, the printer includes a second device configured to obtain optical information from the region, the processor or the computer is further configured to process the optical information to obtain processed optical information, and the evaluation is further based on the processed optical information.

In one or more embodiments, the spectral information includes a backscattered radiation received from the region.

In one or more embodiments, the printer includes a filter configured to filter the backscattered radiation to obtain filtered backscattered radiation.

In one or more embodiments, the first device includes an optical spectrometer and the second device includes a camera.

In one or more embodiments, the camera is coupled to a first port of the printer and the optical spectrometer is coupled to a second port of the printer.

In one or more embodiments, the optical spectrometer and the camera are coupled to a structure.

In one or more embodiments, the energy beam source includes a laser, and the printer includes a shielding component coupled to the structure and configured relative to the optical spectrometer and the laser to prevent damage to the optical spectrometer from reflected power of the laser.

In one or more embodiments, the camera is coupled to a first port of an apparatus and the optical spectrometer is coupled to a second port of the apparatus. The apparatus is coupled to the printer and the apparatus is a housing or an optical instrument.

In one or more embodiments, the optical information includes mushy zone information of the mushy zone.

In one or more embodiments, the printer includes a controller configured to modify a process parameter based on the evaluation.

In one or more embodiments, the controller is further configured to modify the process parameter such that an acceptable temperature of the weld pool is maintained during additively manufacturing of the build piece.

In one or more embodiments, the processor or the computer is further configured to determine at least a temperature profile or a state of the mushy zone from the spectral profile or the spectral intensity.

In one or more embodiments, the printer includes a depositor configured to deposit material, an energy beam source configured to generate an energy beam, the energy beam is configured to melt a region of the material to form a weld pool that cools to form a portion of a build piece, a first device configured to obtain spectral information from the region, and a controller configured to adjust, based on the spectral information, a process parameter to shape the weld pool to obtain a desired effective absorptivity of a portion of the weld pool, e.g., to increase the effective absorptivity relative to an absorptivity of a surface of the powder or material deposited by the depositor.

In one or more embodiments, the spectral information is from the weld pool and includes at least intensity of reflected laser light, a depth, a length, a width, a perimeter, an area or a volume.

In one or more embodiments, the printer includes a depositor configured to deposit material, an energy beam source configured to generate an energy beam, the energy beam is configured to melt a region of the material to form a weld pool that cools to form a portion of a build piece, a first device configured to obtain information of the weld pool, and a controller configured to modify, based on the information, a process parameter to maintain an acceptable temperature of the weld pool during additively manufacturing of a build piece.

In one or more embodiments, the printer includes a depositor configured to deposit material, an energy beam source configured to generate an energy beam, the energy beam is configured to melt a region of the material to form a weld pool that cools to form a portion of a build piece, the weld pool includes a mushy zone, a first device configured to obtain mushy zone information from the mushy zone, and a controller configured to modify a process parameter based on the mushy zone information.

In one or more embodiments, the printer includes a depositor configured to deposit material, an energy beam source configured to generate an energy beam, the energy beam is configured to melt a region of the material to form a weld pool that cools to form a portion of a build piece, the weld pool includes a mushy zone, a first device configured to obtain mushy zone information from the mushy zone, and a processor or a computer in communication with the first device and configured to process the mushy zone information to obtain processed mushy zone information, perform an evaluation based on the processed mushy zone information, and determine a defect condition of the additive manufacturing based on the evaluation.

Other aspects will become readily apparent to those skilled in the art from the following detailed description, wherein is shown and described only several example embodiments by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of the technology will be presented in the detailed description by way of example, and not by way of limitation, in the appended claims and in the accompanying drawings. In the descriptions that follow, like parts are marked throughout the specification and drawings with the same numerals, respectively. The drawing figures are not necessarily drawn to scale and certain figures can be shown in exaggerated or generalized form in the interest of clarity and conciseness.

FIGS. 1A-1D illustrate respective side views of an example Powder Bed Fusion (PBF) system usable with aspects of the disclosure during different stages of operation according to aspects of the disclosure.

FIG. 1E illustrates a functional block diagram of a PBF system in accordance with an aspect of the present disclosure.

FIG. 2 illustrates an example PBF apparatus useable with a 3-D printer including a radiation collector for obtaining radiation and a controller for modifying a process parameter or parameters with closed-loop control.

FIG. 3 illustrates is a side cross-sectional view of the PBF system including a radiation collector.

FIG. 4 illustrates a perspective front view of the PBF system including a first and second devices.

FIG. 5 illustrates an apparatus of the PBF system including a plurality of devices connected to ports of the apparatus.

FIG. 6 illustrates a PBF system including a melt pool and a mushy zone of a region of material.

FIG. 7 illustrates the mushy zone including a relaxation zone and a vulnerable zone.

FIG. 8 illustrates an example keyhole mode.

FIG. 9 illustrates an example spectral intensity obtained and processed from a region of melted powder.

FIG. 10 illustrates an of obtained and processed thermal radiation and spectral intensity.

FIG. 11 illustrates an example of computer coupled to a spectrometer.

FIG. 12 illustrates a method for manufacturing including obtaining and processing spectral information, obtaining an evaluation and determining a defect condition.

FIG. 13 illustrates a method for manufacturing including obtaining spectral information and modifying/adjusting a process parameter based on the spectral information.

FIG. 14 illustrates a method for manufacturing including obtaining mushy zone information and modifying/adjusting a process parameter based on the mushy zone information.

FIG. 15 illustrates a method for manufacturing including obtaining and processing mushy zone information, obtaining an evaluation and determining a defect condition.

### DETAILED DESCRIPTION

In additive manufacturing, solutions have been developed to detect defects within a build piece. However, all of these solutions need to first form the build piece and then use a solution to detect defects within the completed build piece. Thus, the build piece (e.g., a structure, a part) has a defect and may not be acceptable for use and thus incurs costs, waste and lost customer production time when the defective build piece is discarded.

To overcome the above problems associated with the completed build piece including a defect, there is a need to prevent or mitigate a defect from occurring within a build piece while additively manufacturing the build piece by in-situ (i.e., real time) determining a defect condition of the additive manufacturing process. In various embodiments, determining a defect condition may be based on evaluation of obtained and/or processed spectral and/or optical information.

In an embodiment, a process parameter may be modified in-situ (i.e., real time) to mitigate or correct a defect condition within the build piece. The individual or combined use of an Infrared (IR) camera and an optical spectrum analyzer (e.g., optical spectrometer) can be used to monitor weld pool temperature and its spectral radiation signature, for example, in a wavelength range of 10 nm to 10 μm. However, the wavelength range may include wavelengths smaller than 10 nm and/or larger than 10 μm. The camera may be an infrared (IR) camera, a thermal camera, an optical camera, etc. For example, the IR camera can obtain weld pool (i.e., melt pool and mushy zone) transient temperature characterization and monitoring of a region of melted powder, which may include the weld pool (i.e. the melt pool and mushy zone) and an area around the weld pool, while additively manufacturing the build piece. Also, the IR camera can obtain a quality process control variable for dimensional measurement and characterization (width and length) of melt pool and mushy zone for reducing thermal distortions and micro-level and meso-level cracking. The optical spectrum analyzer may be, for example, an optical spectrometer. The optical spectrometer can obtain ultraviolet (UV) to near-infrared (NIR) spectrum information. The optical spectrometer can obtain laser weld process monitoring and characterization via NIR spectral radiation measurements, which include:
i) In-situ monitoring of weld pool state via phase transitions (solid to liquid, liquid to vapor), composition (Mg, Al, etc.) and temperature;
ii) Melt pool size via spectral intensity of one or more components, e.g. for Mg at a wavelength of 279 to 280 nm).

For known material alloy and laser parameters, changes in either weld pool temperature or spectral intensity peaks can be obtained and characterized for known defect types. These defects can include, for example, porosity (e.g., lack of fusion, keyholing), micro/meso-level weld cracks, undesirable microstructure, increased residual stress, elemental composition variation, and undesirable bulk material properties. In various embodiments, actively-controlled monitoring of the lasing process in the early stage of keyholing may allow mitigation or correction that may increase overall process energy efficiency by lowering laser power, which may significantly reduce overall electrical power consumption. Meso-level finite element weld pool simulations may be completed and used to parametrically study and correlate a transient thermal response for a range of laser and process parameters. A machine learning algorithm may be developed and may be used to characterize and learn thermal and spectral signatures in real-time to monitor for undesirable characteristics. A machine learning process parameter relationship may be developed with the in-situ sensor measurements (i.e., obtained spectral information and/or optical information) and may provide feedback control of the build process by actively adjusting process parameters, e.g., laser power, scan speed, beam profile, etc. The combination of real-time process monitoring (e.g., melt pool and mushy zone dimensions, etc.) and learned weld pool state may allow the disclosed methods, systems and apparatuses to mitigate defects before they occur. Melt pool and mushy zone dimensional and temperature (maximum temperature and temperature gradient) measurements can be used to corroborate Finite Element Analysis (FEA) simulations to improve subsequent predictions. Additionally, a high-speed IR camera (e.g., camera having greater than 200 frames per second (fps)) with particle tracking software may be used to characterize and track weld pool splatter.

A three-dimensional (3-D) printer, which includes the below disclosed Powder Bed Fusion (PBF) systems and PBF apparatuses, may include a depositor configured to deposit a plurality of layers of material (e.g., powder) onto a build plate forming a powder bed. The printer may include an energy beam source configured to generate an energy beam that is selectively applied to a surface(s) of the powder associated with the layers of powder to melt a region of the powder, such that the region of powder forms a melt pool. When the energy beam moves away from the region or no longer is applied to the region, the melt pool cools forming a mushy zone, which is a zone generally consisting partly of liquid and partly of solid that typically trails the melt pool as the energy beam scans across the powder layer. After some time the mushy zone further cools to a temperature that it solidifies forming a portion of a build piece. As used herein, the term “weld pool” includes the melt pool and the mushy zone.

The printer may include a plurality of ports or a structure for a first device such as an optical spectrometer and a second device such as a camera to be coupled thereto in order to obtain spectral information and optical information during additively manufacturing the build piece. The printer may include a processor or a computer for processing (i.e., calculating data, performing logic operations of data, and all known processors functions) the obtained spectral information and the obtained optical information during the additive manufacturing of the build piece and for performing an evaluation based on the processed spectral information and/or the processed optical information and based on the evaluation, a determination of a defect condition during the additively manufacturing process of forming the build piece can be made. The processor or the computer may process mushy zone information obtained from the camera and/or the optical spectrometer to perform an evaluation based on the processed mushy zone information and determine a defect condition of the additive manufacturing based on the evaluation. The camera and optical spectrometer may obtain information such as spectral information and optical information from the region of the powder, the melt pool and the mushy zone. The printer may include a controller configured to modify/adjust a process parameter or parameters during the additive manufacturing of the build piece based on the obtained spectral information, the obtained optical information, the processed spectral information and/or the processed optical information from the region of the powder, the melt pool and the mushy zone. The controller may adjust a process parameter or parameters based on information, e.g., obtained information and/or processed information from the region of powder, the melt pool and the mushy zone during additively manufacturing of the build piece. For example, the controller may adjust one or more process parameters in order to shape the weld pool to obtain a desired effective absorptivity of a portion of the weld pool, e.g., to increase the effective absorptivity relative to an absorptivity of a surface of the powder or material deposited by the depositor. The controller may adjust one or more process parameters to maintain an acceptable temperature of the melt pool during additively manufacturing of the build piece.

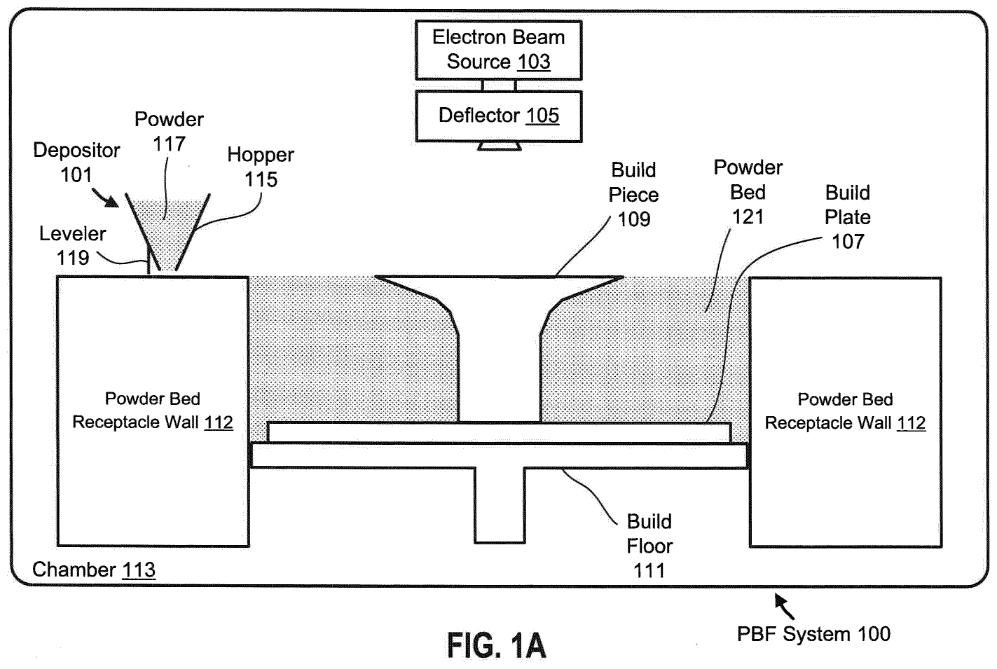

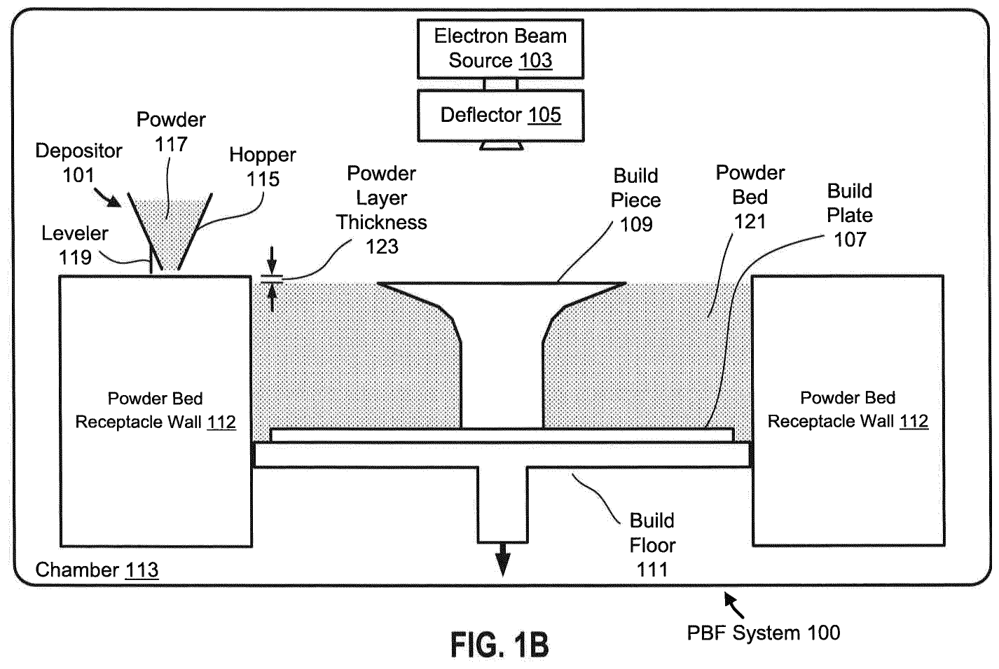

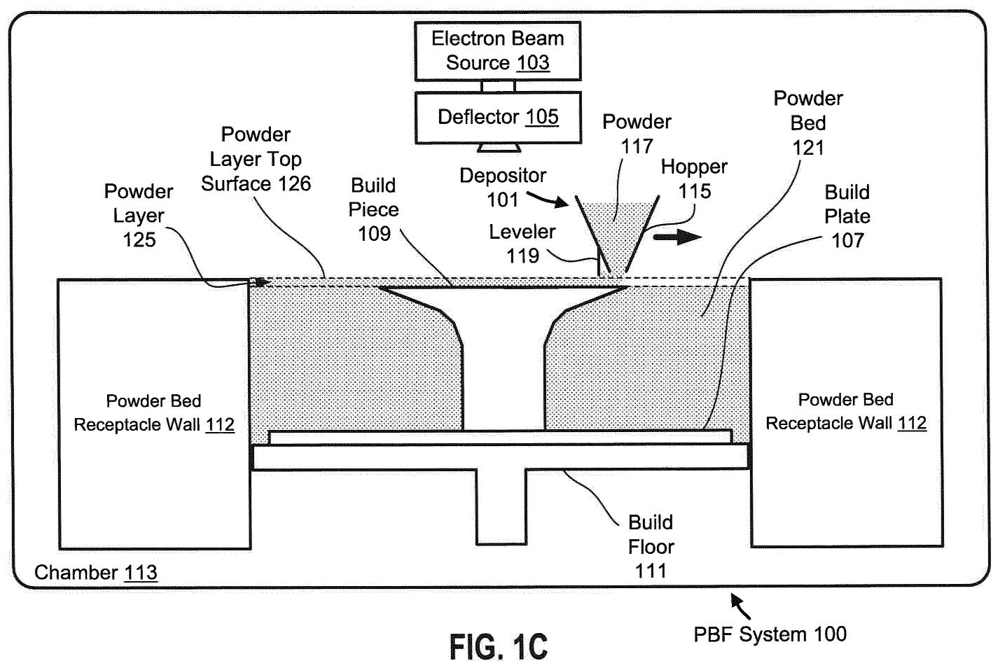

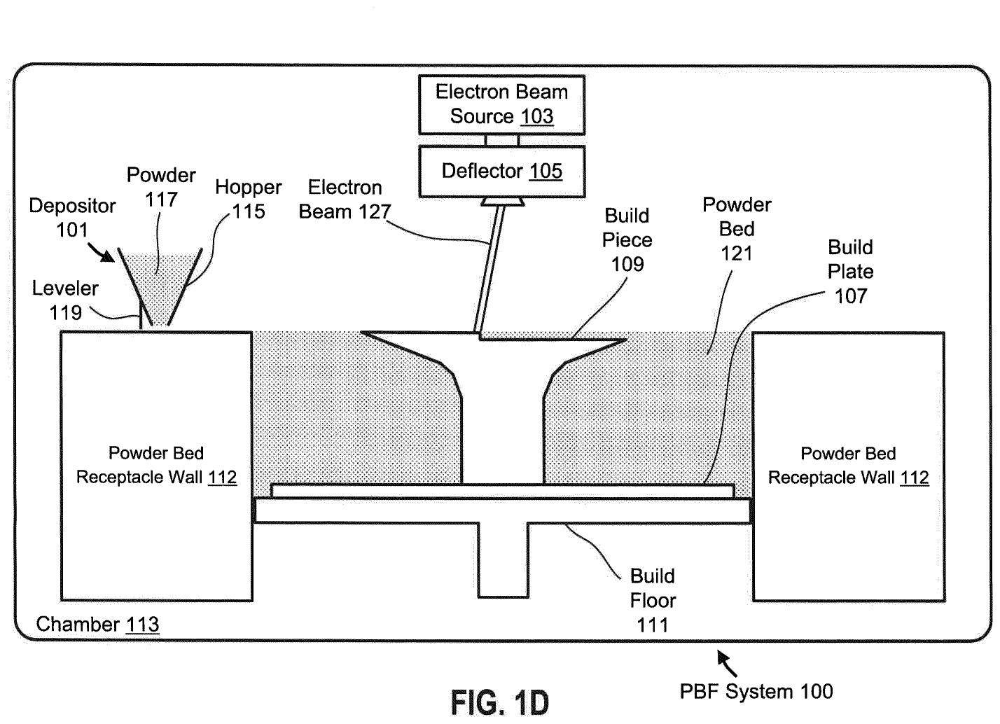

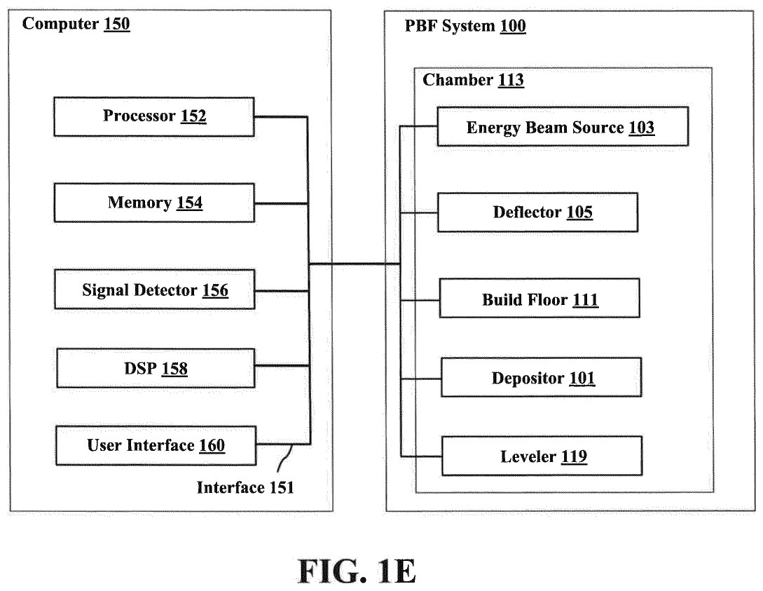

FIGS. 1A-1D illustrate respective side views of an example of a PBF system 100 usable with aspects of the disclosure including a 3-D printer during different stages of operation. As noted above, the particular embodiment illustrated in FIGS. 1A-1D is one of many suitable examples of a PBF system employing principles of this disclosure. It should also be noted that elements of FIGS. 1A-1D and the other figures in this disclosure are simplified and not necessarily drawn to scale, but may be drawn larger or smaller and/or with reduced detail for the purpose of better illustration of concepts described herein. PBF system 100 can include depositor 101 that can deposit each powder layer 125, energy beam source 103 that can generate energy beam 127, deflector 105 that can direct or redirect the energy beam to melt powder 117, and build plate 107 that can support one or more build pieces, such as build piece 109. PBF system 100 can also include build floor 111 positioned within a powder bed receptacle and between powder bed receptacle walls 112. Build floor 111 can progressively lower build plate 107 so that depositor 101 can deposit a next layer. In some examples, all of the above disclosed features of the PBF system may reside in chamber 113 to enclose these features, thereby protecting these features from atmospheric conditions (e.g., providing the features in an inert environment) and temperature regulation and mitigating contamination risks. Depositor 101 can include hopper 115 that contains powder 117, such as a metal (e.g., alloy) or non-metal (e.g., plastic or thermoplastic polymer) powder, and leveler 119 that can level the top of each layer of deposited powder.

Referring specifically to FIG. 1A, this figure shows PBF system 100 after a slice of build piece 109 has been fused by energy beam 127, but before the next layer of powder has been deposited. In fact, FIG. 1A illustrates a time at which PBF system 100 has already deposited and fused a partially completed build piece in multiple layers to form the current state of build piece 109. The multiple layers already deposited have created powder bed 121, which includes powder that was deposited but not melted.

FIG. 1B shows PBF system 100 at a stage in which build floor 111 can lower by powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form powder layer 125 that has a thickness substantially equal to powder layer thickness 123 (see FIG. 1B). Thus, the powder in a PBF system can be supported by a powder material support structure, which can include, for example, build plate 107, build floor 111, build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates energy beam 127 and deflector 105 applies the energy beam to melt the next slice in build piece 109. In various example embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be melted. In various embodiments, energy beam source 103 can be a laser beam source, in which case energy beam 127 is a laser beam. Deflector 105 may include an optical system that uses reflection and/or refraction to manipulate the laser beam to scan selected areas/regions on the powder layer to be melted. In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas/regions of the powder layer. For example, in various aspects of the disclosure, the energy beam can be modulated by a digital signal processor (DSP). The deflector may include any known system in the art, for example a galvo-scanner or galvanometer, and/or a raster scanner. It is noted that while a single energy beam source 103 and/or deflector 105 is shown, aspects of the disclosure are usable with and may include a system with multiple energy source(s) and/or deflector(s).

As shown in FIG. 1D, much of the melting of powder layer 125 occurs in areas/regions of the powder layer that are on top of the previous slice, i.e., previously-melted powder. An example of such an area is the surface of build piece 109. The melting of the powder layer in FIG. 1D is occurring over the previously fused layers characterizing the substance of build piece 109. However, in some areas of powder layer 125, melting can occur on top of loose powder namely, over powder that was not fused inadvertently or otherwise. For example, if the slice area is bigger than the previous slice area, at least some of the slice area will be formed over loose powder. Applying the energy beam to melt an area of powder over loose powder can be problematic. Melted powder is liquefied and generally denser than loose powder. The melted powder can seep down into the loose powder causing drooping, curling, or other unwanted deformations in build piece 109. Because loose powder can have low thermal conductivity, higher temperatures than expected can result when melting powder in overhang areas because the low thermal conductivity can reduce the ability for heat energy to conduct away from fused powder. Higher temperatures in these areas result in higher residual stresses after cooling and, more often than not, a poor-quality build piece. In some cases, dross formations can occur in overhang areas thereby resulting in undesired surface roughness or other quality problems.

FIG. 1E illustrates a functional block diagram in accordance with an aspect of the present disclosure and useable with disclosed 3-D printer, and PBF systems and apparatus. In an aspect of the present disclosure, control devices and/or elements, including computer software, may be coupled to PBF system 100 to control one or more components or process parameters within PBF system 100. Such a device may be a computer 150, which may include one or more process parameters 216 that may assist in the control of PBF system 100. Computer 150 may communicate with PBF system 100, and/or other AM systems, via one or more interfaces 151 (e.g., a bus system). Controller 214, computer 150 and/or interface 151 are examples of devices that may be configured to implement the various systems, apparatuses and methods described herein, that may assist in controlling PBF system 100 and/or other AM systems. Interface 151 may comprise an input/output device that allows controller 214 and/or computer 150 to exchange information with other devices. In some implementations, interface 151 may include one or more of a parallel port, a serial port, or other computer interfaces.

In an aspect of the present disclosure, computer 150 may include at least one processor 152, memory 154, signal detector 156, digital signal processor (DSP) 158, and one or more user interfaces 160. Computer 150 may include additional components without departing from the scope of the present disclosure.

Computer 150 may include at least one processor 152, which may assist in the control, processing and/or operation of PBF system 100. The processor 152 may also be referred to as a central processing unit (CPU). Memory 154, which may include both read-only memory (ROM) and random-access memory (RAM), may provide instructions and/or data to processor 152. A portion of memory 154 may also include non-volatile random-access memory (NVRAM). Processor 152 typically performs logical and arithmetic operations based on program instructions stored within memory 154. The instructions in memory 154 may be executable (e.g., by processor 152) to implement the functions and methods described herein.

Processor 152 may include or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

Processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Computer 150 may also include signal detector 156 that may be used to detect and quantify any level of signals received by computer 150 for use by processor 152 and/or other components of computer 150. Signal detector 156 may detect such signals energy beam source 103 power, deflector 105 position, build floor 111 height, amount of powder 117 remaining in depositor 101, leveler 119 position, and other signals. Signal detector 156, in addition to or instead of processor 152 may also control other components as described with respect to the present disclosure. Computer 150 may also include DSP 158 for use in processing signals received by computer 150 or processor 162. The DSP may be configured to generate instructions and/or packets of instructions for transmission to PBF system 100.

Computer 150 may further comprise user interface 160 in some aspects. User interface 160 may comprise a keypad, a pointing device, and/or a display. User interface 160 may include any element or component that conveys information to a user of computer 150 and/or receives input from the user.

The various components of computer 150 may be coupled together by bus system 151. Bus system 151 may include a data bus, for example, as well as a power bus, a control signal bus, and a status signal bus in addition to the data bus. Components of computer 150 may be coupled together or accept or provide inputs to each other using some other mechanism.

Although a number of separate components are illustrated in FIG. 1E, one or more of the components may be combined or commonly implemented. For example, processor 152 may be used to implement not only the functionality described above with respect to processor 152, but also to implement the functionality described above with respect to signal detector 156, DSP 158, and/or user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (Soc), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by computer 150. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by computer 150. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media). The RAM may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) may include one or more Programmable Read-only Memory (PROM), Erasable Programmable Read-only Memory (EPROM), Electronically Erasable Programmable Read-only memory (EEPROM), flash memory, or other types of non-volatile memory.

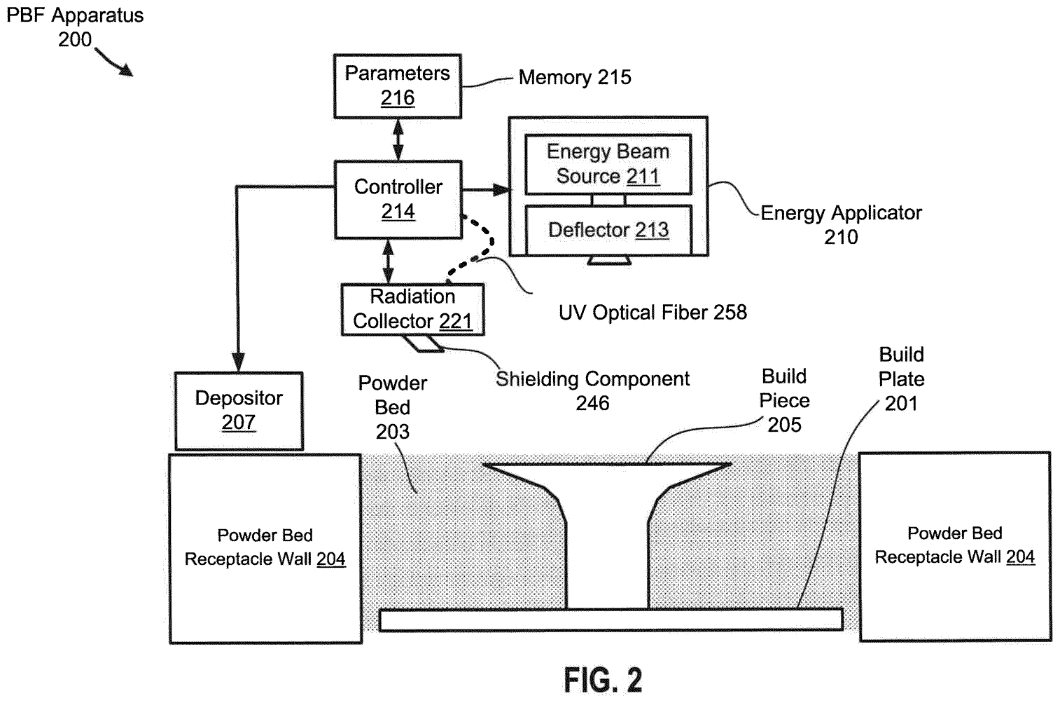

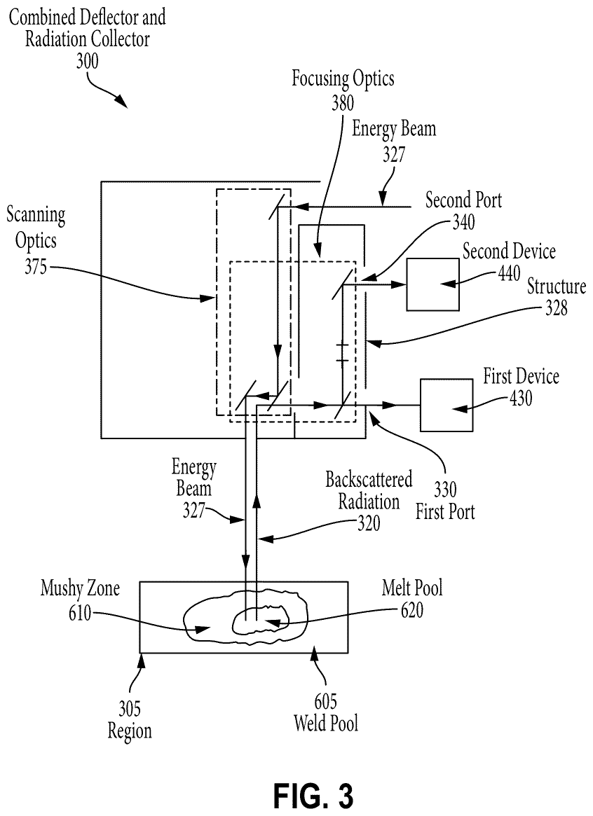

FIG. 2 illustrates an example PBF apparatus 200, which is part of a 3-D printer. In some embodiments, PBF apparatus 200 is configured to collect radiation from a region of material that is melted by an energy beam to form a portion of a build piece and for process parameter modification with closed-loop control. FIGS. 3-7 illustrate in more detail the features of collecting radiation from a region of melted material.

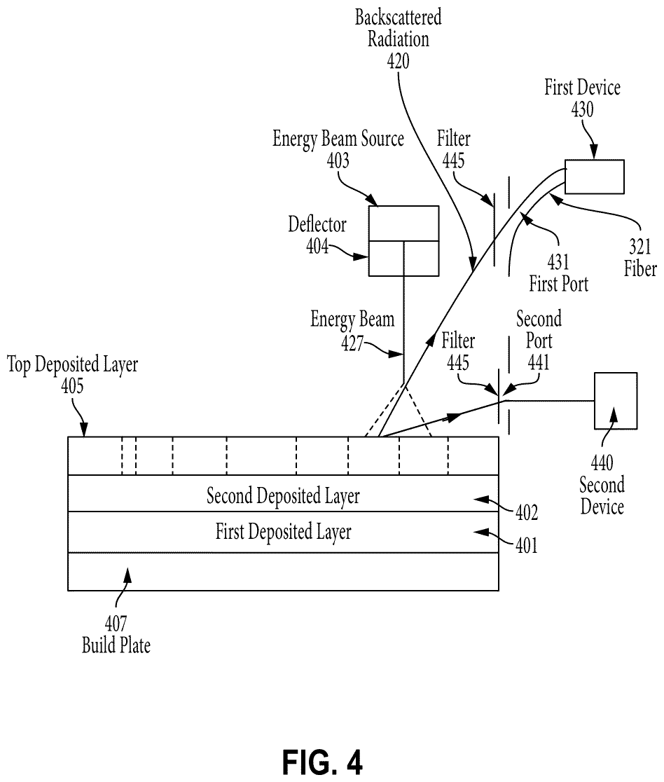

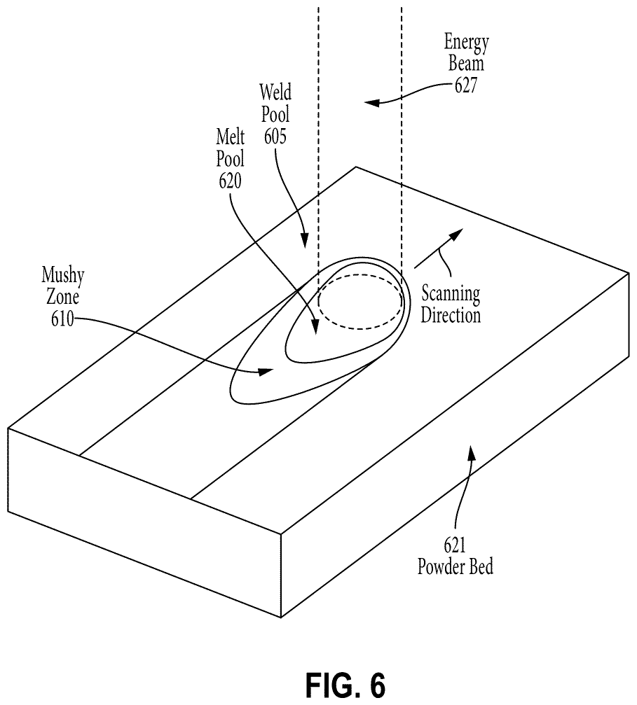

FIG. 2 illustrates build plate 201, powder bed 203 within powder bed receptacle walls 204, build piece 205 in powder bed 203, depositor 207, energy applicator 210, controller 214, radiation collector 221 and shielding component 246. Depositor 207 can deposit layers of material including powder in powder bed 203 during a re-coat cycle (also referred to as a deposit cycle). An energy beam source 211 is configured to apply an energy beam, e.g. energy beam 127, during a scanning cycle to melt the powder in the deposited layers. Radiation collector 221 is configured to obtain/receive radiation from region 305 (shown in FIG. 3), which is a region of powder bed 203 in which energy beam 127 is applied, and process the radiation to obtain spectral information and/or optical information. Controller 214 is configured to process the spectral information and/or optical information to obtain processed spectral information and/or processed optical information, to obtain an evaluation based on the processed information, and to modify process parameter(s) 216 based on the evaluation. Energy beam 127 (see FIG. 1D) is selectively applied to a surface(s) of the powder associated with the layers (401,402,405, see FIG. 4) of deposited powder to melt at least a portion of a region (305, see FIG. 3) of the powder. Region 305 may include a weld pool 605, which may include a melt pool 620 and a mushy zone 610. (see FIG. 6) Melt pool 620 includes the melted powder (i.e., liquid material) within region 305, and mushy zone 610 includes cooling melted powder that generally consists partly of liquid material and partly of solid material.

Energy applicator 210 may include energy beam source 211 and a deflector 213 that uses processor-controlled beam-steering system to steer the energy beam across a deposited layer, such as a galvanometers/mirrors system in the case the energy beam is a laser beam, or sets of magnets and/or grid plates for generating electric and magnetic fields in the case the energy beam is an electron beam.

Radiation collector 221 obtains radiation relating to the depositing of the layer, the melting of the powder material, the composition of the powder material, trace interactions, as well as other states within the 3D printer. In various embodiments, radiation collector 221 is configured to obtain/receive radiation from region 305, where the obtained radiation includes spectral information and optical information. Radiation collector 221 may process the radiation to obtain both spectral information and optical information or may obtain spectral information or optical information. Radiation collector 221 may include one or more devices, (e.g., 430,440 in FIG. 4) which are configured to obtain/receive the radiation with the spectral information and/or optical information from region 305. Radiation collector 221 can collect radiation that radiates from a surface of powder bed 203 and that strikes a receiving surface of the radiation collector. For example, radiation collector 221 can include a camera and/or an optical spectrometer to measure the radiation during a print job. Alternate or additional sensors may be used for similar or different purposes, and using different technologies and devices, and the present disclosure is not limited to the collecting of radiation with the disclosed example sensors in radiation collector 221. Radiation collector 221 can collect radiation in order to determine information about various characteristics of the environment in which the powder bed is present. Other circuits or other components within or outside of radiation collector 221 may use this information to determine characteristics associated with powder bed 203, for example, including material composition and/or trace interactions. The UV spectrum, for example, may also include other information about the process, such as the frequency response of the scanning, the amount of total UV radiation, the composition of the materials and whether contaminants are present (e.g., using spectroscopy over the UV range), and similar capabilities. As noted, controller 214, or a dedicated processor circuit may elicit information in various ways from the UV spectrum. This information may be stored in memory. The processor or other circuitry may use the radiation in these UV frequencies/ranges to determine information associated with a relevant portion of the powder bed 203. Using this data, controller 214 can adjust various configurations and/or printer parameters of the PBF apparatus 200 (e.g., the intensity of the energy beam), e.g., in real time, during the next anticipated scanning cycle, or for an entirely separate build process. Radiation collector 221 may be configured to receive radiation in the UV spectrum during a scanning cycle. That is, radiation collector 221 may collect UV radiation when energy applicator 210 controls energy beam source 211 to apply an energy beam, which causes the powder material in one or more deposited layers to fuse and disturb elements (e.g., powder and other particles). In some embodiments, radiation collector 221 may be configured to obtain radiation along a path corresponding to the point at which the energy beam strikes the surface of powder bed 203, which may also be known as the weld site. For example, controller 214 may control movement of radiation collector 221 so that an unobstructed UV optical path is maintained between radiation collector 221 and the weld site. In another example, radiation collector 221 may be connected to energy applicator 210 such that movement of energy applicator 210 (e.g., the movement of a galvanometer/mirror system in the energy applicator) causes radiation from the weld site (e.g., backscattered radiation) to be steered toward radiation collector 221.

Spectral information can include a spectral profile, electromagnetic radiation, all electromagnetic waves of the electromagnetic spectrum, spectral intensity, thermal radiation from region 305, electron emissions from region 305, radiation from electron state transitions from region 305 and backscattered radiation 320 (see FIG. 3), wherein backscattered radiation 320 can include reflected energy such as reflected laser beam energy from region 305. Although the various embodiments described herein focus on radiation generated by interaction with a laser beam, one skilled in the art will readily understand how the disclosed principles may be applied to other energy beams, such as electron beams.

Optical information can include thermal radiation from region 305, electromagnetic radiation, all electromagnetic waves of the electromagnetic spectrum, which can include infrared (IR) light, near-infrared (NIR) light, visible light and ultraviolet (UV) light, and backscattered radiation 320 (see FIG. 3), wherein backscattered radiation 320 can include reflected energy such as reflected laser beam energy from region 305.

Obtaining the spectral information and/or optical information can include obtaining any or all physical processes of the spectral information and optical information such as capturing thermal radiation, electromagnetic radiation, all electromagnetic waves of the electromagnetic spectrum, and backscattered radiation 320 and/or filtering thermal, electromagnetic and backscattered radiation, as well as all electromagnetic waves of the electromagnetic spectrum, etc.

Spectral information and/or optical information can be obtained by, for example, a first device, which may include a camera or a spectrometer and a second device, which may include a camera or a spectrometer. The camera may include a thermal camera, an optical camera, an IR camera, etc. The spectrometer may include an optical spectrum analyzer, an optical spectrometer to perform optical spectroscopy, etc.

Processor 152 or computer 150 is coupled to the first device and the second device and configured to process the spectral information and the optical information obtained from the first device and second device to obtain processed spectral information and processed optical information, to perform an evaluation based on the processed spectral information and/or the processed optical information, and to determine a defect condition of the additive manufacturing based on the evaluation.

Processor 152 or computer 150 may be in wireless communication or in wired communication with the first device and the second device. Processor 152 or computer 150 processing the spectral information and the optical information includes computer processing of data and information of the spectral information and the optical information.

A defect condition of the additive manufacturing process (i.e., additively manufacturing the build piece) may include:
i) a defect in the build piece such as porosity (caused by keyholing, lack of fusion etc.), larger pores, interlaminar weld cracks, microstructure changes, increased residual stress, elemental composition variation, material property changes, or other defect types;
ii) a condition that is conducive to causing a defect in the build piece (e.g., keyholing, an erred subsequent layer, where the layer is too large or small in width, height or depth, the layer has large or small deviations (i.e., undulations) in the surface; defect in the laser beam, process parameter (e.g., incorrect shape, profile or spot size, incorrect power to energy applicator, etc.);
iii) defect in the powder bed (e.g., too thick or thin, contains grooves and/or undulations in a layer or layers of the powder bed).

Also, defects may include increased build time and material costs due to sub-optimal additively manufacturing conditions.

An evaluation may use processor 152, computer 150 or a combination of the processor and computer to compare obtained and processed spectral and processed information with a value, criterion, criteria, data such as historical data from previously additive manufacturing processes, and/or data from the above defect conditions. For example, an evaluation may include:
i) an evaluation based on a difference between the spectral information and a criterion being above or below a numerical value or range of an acceptable criteria;
ii) an evaluation based on a difference between the optical information and a criterion being above or below a numerical value or range of an acceptable criteria;
iii) an evaluation based on a ratio of a value of a characteristic of the melt pool and a value of a criterion;
iv) an evaluation based on a ratio of a value of a characteristic of the mushy zone and a value of a criterion;
v) an evaluation based on a change in a value of the spectral intensity during additively manufacturing of the build piece;
vi) an evaluation of the melt pool having an acceptable temperature range during additively manufacturing of the build piece to prevent any defect condition (i.e. any of the above defects).

Controller 214 is coupled to and in communication with process parameters 216, radiation collector 221, energy beam applicator 210, computer 150 and processor 152 in order to be configured to modify a process parameter based on the evaluation. A process parameter includes, for example, laser power, hatch spacing, scan speed, a beam profile of the laser beam, a beam size of the laser beam, a beam shape of the laser beam or any combination thereof. Controller 214 may be further configured to modify the process parameter such that a temperature of the melt pool is maintained within an acceptable range during additively manufacturing of the build piece. Controller 214 may be configured to adjust, based on the spectral information, a process parameter to shape the weld pool to obtain a desired effective absorptivity of a portion of the weld pool, e.g., to increase the effective absorptivity relative to an absorptivity of a surface of the powder or material deposited by the depositor. Controller 214 may be configured to modify, based on the information, a process parameter to maintain an acceptable temperature, which may include a range of temperatures, of the melt pool during additively manufacturing of a build piece. Controller 214 may be configured to modify a process parameter based on the mushy zone information.

In some implementations, as part of or incorporating various features and methods described herein, one or more microcontrollers may be implemented for controlling any one or combination of the operations described herein (e.g., the operations of the PBF system and/or support removal systems and apparatuses described herein). Controller 214 includes a CPU, RAM, ROM, a clock and timer, a BUS controller, an interface, and an analog-to-digital converter (ADC) interconnected via a BUS. The CPU may be implemented as one or more single core or multi-core processors, and receive signals from an interrupt controller and a clock. The clock may set the operating frequency of the entire microcontroller and may include one or more crystal oscillators having predetermined frequencies. Alternatively, the clock may receive an external clock signal.

Controller 214 can be, for example, a computer processor. Controller 214 may, for instance, be either one or both of a print controller and processor 152 with reference to spectral and optical information such as radiation. In some embodiments, controller 214 may be a print controller for controlling principal functions of the PBF apparatus 200 such as re-coat printer parameters, scanning type, scanning speed, beam intensity, beam steering, etc. That is, controller 214 may issue instructions for directing the energy beam to move across the powder bed so as to print the structure previously modeled using computer-aided design. In some embodiments, controller 214 may be a processor that performs both general print functions and oversight of the PBF apparatus 200, and functions related to control as described further herein. In other embodiments, the processor (e.g., FIG. 1E) may be distinct from the print controller. The two processing elements (e.g., controller 214 and processor 152) can generally communicate via a bus or other wiring. This communication enables the print controller to modify one or more printer parameters based on information from the processor. Controller 214 can control depositor 207 to deposit a layer of material, can control energy beam source 211 to generate the energy beam, and can control deflector 213 to scan the energy beam across the deposited layer in a precise manner to obtain build piece 205. Further, in various embodiments, controller 214 can control the above recited components in the manner recited by using different determined values or types of printer parameters, and/or by using different determined subsets or combinations of printer parameters, in order to achieve a desired result for the specific printing operation at issue (such as managing overhangs, enhancing surface finish quality, optimizing printing speed, optimizing an overall combination of these and other operations, etc.)

Process parameter modification may include, for example, reducing or increasing the hatch spacing, scan speed, a beam profile of the laser beam, a beam size of the laser beam, or a beam shape or the intensity of the energy beam such as the laser beam intensity, layer thickness, gas flow (e.g., the flow of a gas across the surface of the powder bed), and other actions described herein.

In some other embodiments, PBF apparatus 200 is configured for data collection and analysis. For example, during the manufacture of build piece 205, PBF apparatus 200 may be configured to contemporaneously collect data associated with process states, as well as data associated with build piece 205 and/or powder bed 203 used in the manufacture thereof (e.g., data on material composition). Such collected data may be used for quality control, such as in determining deviations from material compositions. Additionally, such collected data may be used to adjust printer parameters 216 and/or otherwise configure PBF apparatus 200 for future print operations, such as by developing mathematical and/or heuristics functions designed to enhance material properties and ensure consistency in the build process.

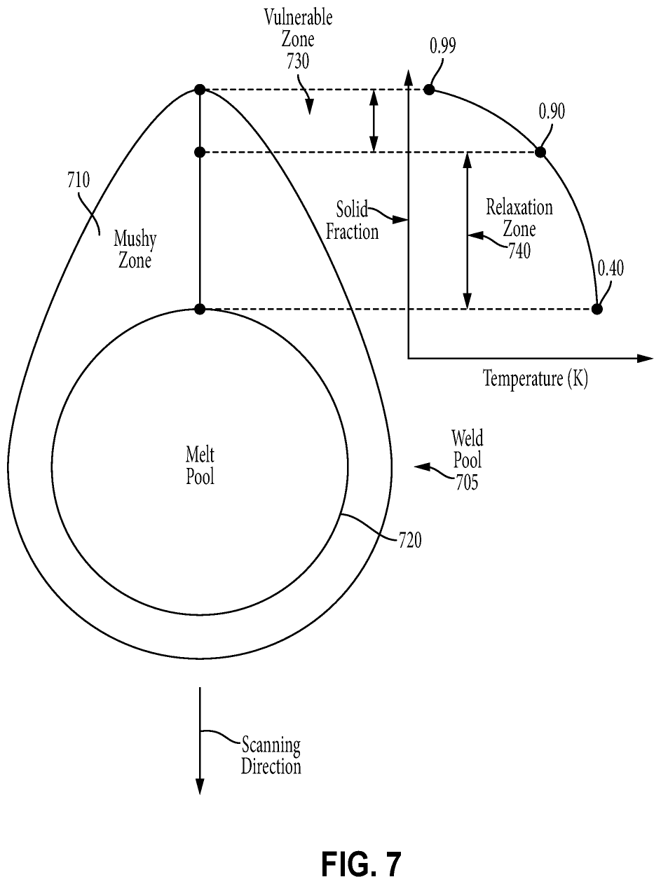

FIG. 3 illustrates a combination deflector and radiation collector 300 according to various embodiments. An energy beam 327 may be provided (e.g., from an energy beam source such as 211 in FIG. 2) and applied via a scanning optics 375 to the powder within region 305 forming weld pool 605, including melt pool 620 and mushy zone 610. A detailed view of the weld pool is illustrated in FIGS. 6 and 7. In this embodiment, scanning optics 375 perform the function of a deflector, such as deflector 213, and may be considered a deflector. Due to energy beam 327 being applied to the powder in region 305, backscattered radiation 320 is reflected from region 305, e.g., from weld pool 605, through focusing optics 380 and to a first device 430 and a second device 440 via first port 330 and second port 340, respectively. First device 430 and second device 440 may include devices that can process backscattered radiation 320 to obtain spectral information and/or optical information. In this embodiment, first device 430, second device 440, first port 330, second port 340 and focusing optics 380 perform the function of a radiation collector, such as radiation collector 321, and may be considered a radiation collector.

Focusing optics 380 may include components such as a lens, a plurality of lenses and/or mirrors, etc. that steer backscattered radiation 320 to a first port 330 and a second port 340, described below. In this embodiment, focusing optics 380 and scanning optics 375 share some optical elements. Focusing optics 380 may additionally include filter 435 and/or 445 (see FIG. 4) that filters backscattered radiation 320 to obtain filtered backscattered radiation. The filter may include an optical filter, a lens, a lens including transparent material such as UV-transparent material. The filter may be coupled to a port or ports of a 3-D printer. For example, the filter may include a plurality of filters 435,445.

In this embodiment, first device 430 and second device 440 may be coupled to structure 328. The first device may be coupled to first port 330 of the structure such that the spectral information and/or the optical information may be obtained by the first device in a first field of view of region 305 of melted powder. Second device 440 may be coupled to second port 340 of the structure such that the spectral information and/or the optical information may be obtained by the second device in a second field of view of region 305 of melted powder. The first field of view and second field of view may include the spectral and optical information. Both the first device and the second device may be coupled to a single port of the 3-D printer, or the first device may be coupled to a first port of the 3-D printer and the second device may be coupled to a second port of the 3-D printer. In an embodiment, the first device or the second device may be couple to a port of the 3-D printer. However, more than two devices may be coupled to a port of the 3-D printer, or each device may be coupled to each port of the 3-D printer. The 3-D printer may include more than two ports.

Region 305 may include weld pool 605, with melt pool 620 and mushy zone 610 (sec FIG. 6 for a more detailed view). Melt pool 620 includes the liquid, melted powder within region 305. Mushy zone 610 generally consists partly of liquid, melted powder and partly of solid material resulting from cooling of the melted powder. The first device includes a camera or a spectrometer. The second device includes a camera or a spectrometer. The camera may include a thermal camera, an optical camera, an IR camera, etc. The spectrometer may include an optical spectrum analyzer, an optical spectrometer to perform optical spectroscopy, etc.

FIG. 4 illustrates PBF system 400 including build plate 407 supporting layers 401,402,405 of deposited powder (with layers 401 and 402 having been selectively fused in previous scans), energy beam source 403 generating energy beam 427 and deflector 404 scanning the energy beam to selectively apply the energy beam to a surface(s) of layer 405 of deposited powder to melt at least a portion of a region (305, see FIG. 3) of the powder. Backscattered radiation 420 is reflected from the surface of the powder and is obtained by first device 430 and second device 440 via first port 431 and second port 441. The first device includes a camera or a spectrometer. The second device includes a camera or a spectrometer. The camera may include a thermal camera, an optical camera, an IR camera, etc. The spectrometer may include an optical spectrum analyzer, an optical spectrometer to perform optical spectroscopy, etc. In this embodiment, first device 430, second device 440, first port 431, and second port 441 perform the function of a radiation collector, such as radiation collector 321, and may be considered a radiation collector. In this embodiment, the deflector is separate from the radiation collector.

Filter 435 or 445 may be included in PBF system 400 to filter backscattered radiation 420 to obtain filtered backscattered radiation. The filter may include an optical filter, a lens, a lens including transparent material such as UV-transparent material. The filter may be coupled to a port of the 3-D printer. For example, the filter may include a plurality of filters 435,445.

Focusing optics such as focusing optics 380 of FIG. 3 may be included in various embodiments such as FIG. 4. Focusing optics 380 may include a lens or a plurality of lenses and/or mirrors to provide backscattered radiation 420 to first device 430 and second device 440.

First device 430 may be coupled to first port 431 such that the spectral information and/or the optical information may be obtained by the first device in a first field of view of a region (305, see FIG. 3) of melted powder. Second device 440 may be coupled to second port 441 such that the spectral information and/or the optical information may be obtained by the second device in a second field of view of a region (305, see FIG. 3) of melted powder. The first field of view and second field of view may include the spectral and optical information. Both the first device and the second device may be coupled to a single port of the 3-D printer, or the first device may be coupled to a first port of the 3-D printer and the second device may be coupled to a second port of the 3-D printer. In an embodiment, the first device or the second device may be couple to a port of the 3-D printer. However, more than two devices may be coupled to a port of the 3-D printer, or each device may be coupled to each port of the 3-D printer. The 3-D printer may include more than two ports. Melt pool 620 includes the melted powder within region 305.

In various embodiments including FIGS. 3 and 4, shielding component 246 may be coupled to radiator collector 221,321 or structure 328 and configured to prevent damage to the optical spectrometer from reflected power of energy beam source 103,211 such as a laser. Shielding component 246 may include an optical filter; a protective lens; a low-pass filter; UV-transparent material such as a film or a film on a lens; and/or a wall or a barrier material that prevents radiation from penetrating therethrough. Shielding component 246 is configured to reduce or eliminate interference with the functionality of the optical spectrometer.

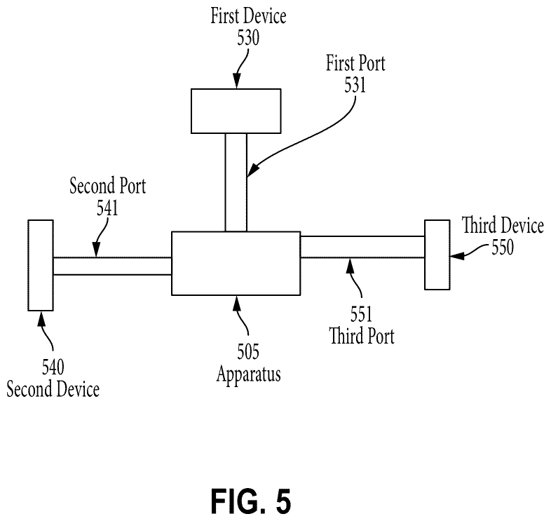

FIG. 5 illustrates details of apparatus 505. Apparatus 505 may be coupled to a 3-D printer and is a housing or an optical instrument. Apparatus 505 includes first device 530 coupled to port 531. Apparatus 505 may include second device 540 coupled to second port 541. Apparatus 505 may include third device 550 coupled to third port 551. Each device is coupled to a port such that the spectral information and/or the optical information may be obtained by each first device from a field of view of a region (e.g., 305) of melted powder, wherein the region includes melt pool 620 and mushy zone 610. Apparatus 505 may have more than three ports or fewer than three ports. Also, Apparatus 505 may have more than three devices or fewer than three devices. The first device includes a camera or a spectrometer. The second device includes a camera or a spectrometer. The camera may include a thermal camera, an optical camera, an IR camera, etc. The spectrometer may include an optical spectrum analyzer, an optical spectrometer to perform optical spectroscopy, etc.

FIG. 6 illustrates a larger view of weld pool 605 in a powder bed 621 formed from deposited powder, and energy beam 627 selectively applied to a surface of the powder to melt at least a portion of a region of the powder forming melt pool 620 and when the melt pool cools, mushy zone 610 is formed. Thus the weld pool includes the melted region of the powder and the mushy zone.

FIG. 7 illustrate details of mushy zone 710, including a vulnerable zone 730 and a relaxation zone 740. Mushy zone 710 is a result of melting and solidification occurring over a temperature range over a region of material. Therefore, mushy zone 710 is the coexistence of a liquid and a solid of material. The material being processed (3D printed) may include a metal, a metallic powder or other materials. FIG. 7 illustrates that the mushy zone can include a larger percentage of solid material (i.e. solid fraction) at lower temperatures and a smaller percentage of solid material at higher temperatures. In other words, as the mushy zone cools, more solid material forms. The portion of the mushy zone that is relatively less solid (i.e., relatively more liquid) can continue to cool and solidify as the temperature decreases without problem. However, once the material reaches a certain percentage of solid, further cooling may result in problems, such as cracking, susceptibility to cracking, or large grain size. Thus, the mushy zone may be divided into relaxation zone 740, which contains enough liquid to avoid cracking, and vulnerable zone 730, which contains enough solid to make it vulnerable to cracking. In the example weld pool 705, the solid fraction that divides the relaxation and vulnerable zones is 0.9. The vulnerability of vulnerable zone 730 to solidification cracking could translate into build piece 205 including cracks. In various embodiments, such cracks may be a defect condition. In this example, the boundary between vulnerable zone 730 and relaxation zone 740 is defined by a solid fraction or 0.90. In other embodiments, the boundary may be different depending on factors such as the elemental composition of the material. In order to prevent cracks or thermal tearing in the build piece, it can be desirable that the vulnerable zone is as small as possible. In other words, it can be desirable to minimize the ratio of vulnerable zone to relaxation zone.

Therefore, in various embodiments, the camera and/or the spectrometer may obtain mushy zone information from the mushy zone, and a process parameter may be modified based on the obtained mushy zone information in order to prevent cracks and/or large grain size in the build piece. Mushy zone information includes at least temperature information, temperature gradient, solidification rate, shape information, shape or a ratio of a length of the relaxation region and a length of the vulnerable region. The shape or shape information of the mushy zone information includes a depth, a length, a width, a perimeter, an area or a volume. Relaxation zone 740 may include a zone of solidification stress. For example, relaxation zone 740 may range from solid fractions between 0.4 to 0.9.

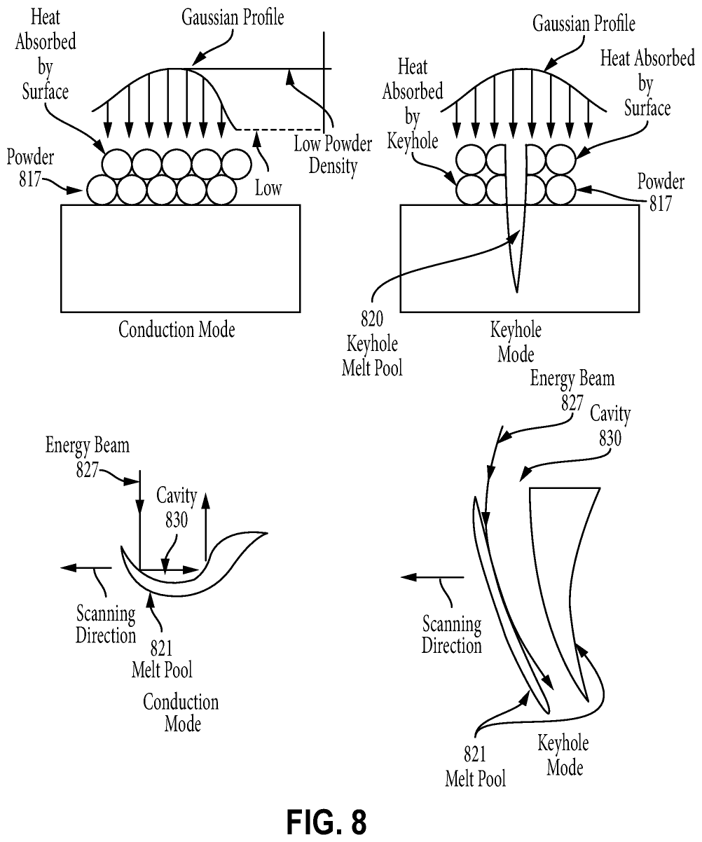

FIG. 8 illustrates two different modes than can occur in melt pools. A conduction mode can occur when the melting of the powder by the energy beam, e.g., a laser beam, creates gas, and the gas causes a gas pressure to push the surface of the melt pool downward and creates a shallow cavity in the melt pool. Conduction mode can be beneficial because the shallow cavity can cause a greater effective absorption of the laser beam energy because lasing photons can reflect multiple times in the cavity (as shown in FIG. 8), which can give the lasing photons more opportunities to be absorbed.

In contrast, a keyhole mode when powder is melted. A keyhole mode (i.e., keyholing) occurs when the gas pressure is too high and causes a deep cavity to form in the melt pool. Keyhole mode can cause bubbles to form in the solidified material as the melt pool moves during scanning and the deep cavity collapses with gas trapped inside. In various embodiments, trapped bubbles can be a defect condition because trapped bubbles are considered a defect in the material. In various embodiments, keyhole mode can be a defect condition because the keyhole mode is a condition that is conducive to producing defects such as bubbles.

Actively controlled monitoring to determine whether the melt pool is in keyhole mode, and if so modifying process parameters to cause the melt pool to be in conduction mode, can improve the additively manufacturing overall process energy (electrical power) efficiency and prevent or mitigate a defect condition. This may be performed by modifying the lasing process (e.g., apply the energy/laser beam to the surface of the powder and melting the powder) when the melt pool is determined to be in keyhole mode, preferably in the early stage of keyholing. During the early stage of keyholing the effective absorptivity significantly increases from the typical surface absorptivity of the powder material because a greater number of lasing photons are allowed to be absorbed in the wall of the shallow keyhole well (as shown in FIG. 8). In other words, the lasing photons are lost down the deep cavity and absorbed. For example, effective absorptivity for Aluminum in keyholing mode may be increased from 0.15 to 0.70, an increase of 460%. Laser and process parameters can be actively controlled to stabilize and maintain this efficient melt pool state or condition. As illustrated in FIG. 8 and from any of the above disclosed PBF systems and apparatuses, powder 817 may be melted with energy beam 827 and the melted powder forms keyhole melt pool 820. The melt pool is continuously monitored via the camera and/or spectrometer during additively manufacturing build piece 205 to indirectly determine the state of the liquid melt and elemental transitions to vapor. It is noted the vaporization temperature for aluminum is approximately 2300 C at 1 barr. Keyhole melt pool 820 has a shape that is round and large on a top surface and has a thin/narrow shaped spike at a bottom surface. This keyhole melt pool 820 shape resembles a keyhole in a warded lock. Thus, the term keyhole may be derived from this type of lock. Powder melting in a keyhole mode may lead to defects in the build piece. However, the disclosure prevents defects within the build piece by maintaining melt pool 821 within an acceptable temperature range and/or shape by adjusting a process parameter, preferably to keep the melt pool in conduction mode. For example, forming the shape of melt pool 821 having cavity 830 prevents keyhole melt pool 820 and thus prevents defects within the build piece Thus, a determination of a defect condition may be based on an evaluation of a characteristic of the melt pool. The characteristic of the melt pool includes at least keyhole information, a dimension, a shape, a temperature or a temperature gradient. The shape includes a depth, a length, a width, a perimeter, an area or a volume of the melt pool. Keyhole information may include shape of the melt pool, cavity shape and/or size of the melt pool, temperature and temperature gradient of the melt pool, flow such as velocity within the melt pool. Also, to avoid keyholing and associated large diameter spherical voids, the optical spectrometer may be used to detect spectral information. (e.g., spectral intensity and the presence of photon emissions related to electron transitions).

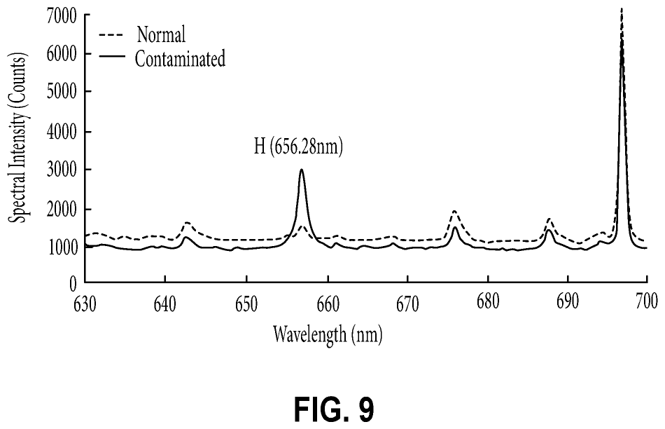

FIG. 9 illustrates an example of obtaining spectral intensity from the optical spectrometer and processing the obtained spectral intensity with computer 150 or processor 152 or a combination of the computer and processor from a region of melted powder, which includes the melt pool and mushy zone, during additively manufacturing build piece 109. The Normal dashed line within the graph of FIG. 9 illustrates conditions considered normal additively manufacturing operation conditions (i.e., additively manufacturing conditions found without a defect condition) during additively manufacturing of build piece 109. The Contaminated line within the graph of FIG. 9 illustrates a condition considered to have a defect condition during additively manufacturing of build piece 109. For example, in this example, the defect condition is a larger spectral intensity presence of H (Hydrogen spectral intensity) found than would be found during normal additively manufacturing operation conditions. However, a defect condition may be determined or based on the spectral intensity including a water vapor spectral intensity or a magnesium spectral intensity. The spectral intensity of hydrogen can be directly related to the presence of moisture and hydrocarbon contaminants. An increase in hydrogen may lead to an increase in gas pore defects. This defect condition was determined based on an evaluation of the obtained processed spectral intensity compared to normal operation conditions of additively manufacturing build piece 109. The presence and relative amounts of metal or other elements can be detected by a spectral profile (i.e., spectral intensity distribution over a region of powder such as melted powder in the melt pool or mushy zone) or the optical intensity/spectroscopy of the optical spectrometer or by optical information from the optical camera. The spectral information includes at least a spectral profile or spectral intensity. The processor or the computer is configured or further configured to determine at least a temperature profile or a state of the mushy zone from the spectral profile or the spectral intensity. The processed spectral information may be a change in a value of the spectral intensity during additively manufacturing of the build piece.

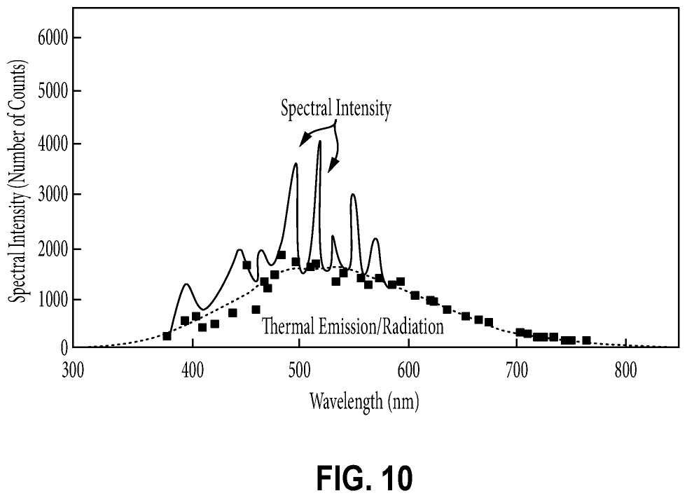

FIG. 10 illustrates an example of thermal radiation obtained by the optical camera, spectral intensity obtained by the optical spectrometer, and the computer or processor or the combination of the computer and processor processing the obtained thermal radiation and the obtained spectral intensity. The obtained thermal radiation and the obtained spectral intensity were obtained from a surface of the melt pool during additively manufacturing build piece 109. The approximate surface temperature of the melt pool can be determined by the decomposition of the obtained narrow elemental spectral emissions/intensity, as illustrated in FIG. 10, and superimposing the obtained narrow elemental spectral emissions/intensity on obtained and processed broad temperature emissions (i.e., thermal radiation) from a surface of the melt pool. The presence and relative amounts of metal or other elements can be detected by the optical intensity/spectroscopy of the optical spectrometer.

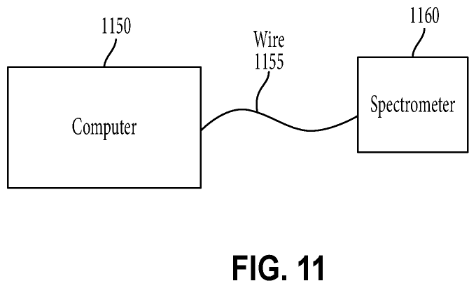

FIG. 11 illustrates an example of computer 1150 coupled to spectrometer 1160 using wire 1155 in order for computer 1150 to process obtained spectral information from a region of melted powder, which includes the melt pool and mushy zone by the spectrometer. However, computer 1150 may be coupled to spectrometer 1160 using a wireless communication. Spectrometer 1160 is configured to obtain spectral information from a region of melted powder, which includes the melt pool and mushy zone and then provide the obtained spectral information to computer 1150 or a processor or a combination of the computer and the processor.

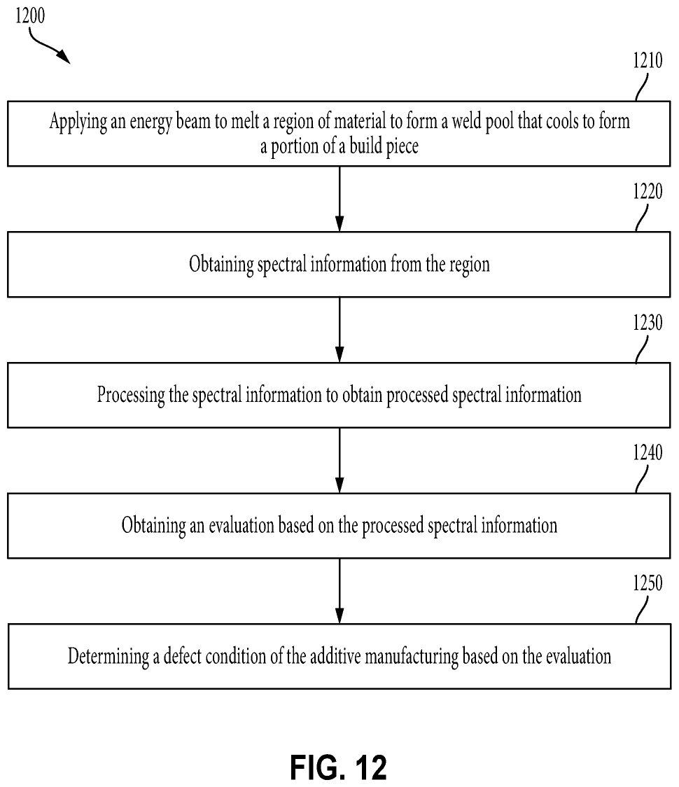

Referring to FIG. 12, a flow chart illustrates an example method 1200 of manufacturing. Method 1200 may be performed with any of the disclosed PBF systems and apparatuses, such as PBF system 100 and PBF apparatus 200. Method 1200 may include applying an energy beam to melt a region of material to form a melt pool that cools to form a portion of a build piece. (1210) The energy beam may be a laser beam that melts a surface of powder in a region that may have been deposited from a depositor. The melted powder includes a melt pool, and the melt pool includes a mushy zone.

Method 1200 may include obtaining spectral information from the region of melted powder. (1210) Spectral information includes a spectral profile, electromagnetic radiation, all electromagnetic waves of the electromagnetic spectrum, spectral intensity, thermal radiation from region 305, electron emissions from region 305, radiation from electron state transitions from region 305 and backscattered radiation 320 (see FIG. 3), wherein backscattered radiation 320 includes a reflected energy beam such as a reflected laser beam from region 305. Also, obtaining the spectral information includes controlling an optical spectrometer to perform optical spectroscopy at a second port with a second field of view of the region of the material, wherein a controller may perform the function of controlling.

Method 1200 may include processing the spectral information to obtain processed spectral information. (1230) A computer or process or a combination of a computer and a process may the obtained spectral information from a region of powder.

Method 1200 may include obtaining an evaluation based on the processed spectral information. (1240) An evaluation may use processor 152, computer 150 or a combination of the processor and computer to compare obtained and processed spectral and processed information with a value; criterion; criteria; data such as historical data from previously additive manufacturing processes; and/or data from the above defect conditions. For example, an evaluation may include: i) an evaluation based on a difference between the spectral information and a criterion being above or below a numerical value or range of an acceptable criteria; ii) an evaluation based on a difference between the optical information and a criterion being above or below a numerical value or range of an acceptable criteria; iii) an evaluation based on a ratio of a value of a characteristic of the melt pool and a value of a criterion; iv) an evaluation based on a ratio of a value of a characteristic of the mushy zone and a value of a criterion; v) an evaluation based on a change in a value of the spectral intensity during additively manufacturing of the build piece; vi) an evaluation of the melt pool having an acceptable temperature range during additively manufacturing of the build piece to prevent any defect condition (i.e. any of the above defects) and any evaluations disclosed form the above disclosed PBF systems and apparatuses.

Method 1200 may include determining a defect condition of the additive manufacturing based on the evaluation. (1250) A defect condition of the additive manufacturing process (i.e., additively manufacturing the build piece) may include: i) a defect in the build piece such as porosity (keyholing, lack of fusion etc.), larger pores, interlaminar weld cracks, microstructure changes, increased residual stress, elemental composition variation, material property changes, or other defect types; ii) a condition that might later lead to a defect in the build piece (e.g., an erred subsequent layer, where the layer is too large or small in width, height or depth, the layer has large or small deviations (i.e., undulations) in the surface; defect in the laser beam, process parameter (e.g., incorrect shape, profile or spot size, incorrect power to energy applicator, etc.); iii) defect in the powder bed (e.g., too thick or thin, contains grooves and/or undulations in a layer or layers of the powder bed) and any evaluations disclosed form the above disclosed PBF systems and apparatuses. Also, defects may include increased build time and material costs due to sub-optimal additively manufacturing conditions.

Method 1200 may also include obtaining optical information from the region of melted powder. The optical information includes thermal radiation from region 305, electromagnetic radiation, all electromagnetic waves of the electromagnetic spectrum, which includes infrared (IR) light, near-infrared (NIR) light, visible light and ultraviolet (UV) light, and backscattered radiation 320 (see FIG. 3), wherein backscattered radiation 320 includes a reflected energy beam such as a reflected laser beam from region 305. Also, obtaining the optical information may include controlling a camera to perform optical imaging at a first port with a first field of view of the region of material such as powder. The first and second field of view may be the same.

Method 1200 may also include processing the optical information to obtain processed optical information. A computer or process or a combination of a computer and a process may the obtained optical information from a region of powder.

Method 1200 may also include the evaluation is further based on the processed optical information. For example, an evaluation may include: i) an evaluation based on a difference between the spectral information and a criterion being above or below a numerical value or range of an acceptable criteria; ii) an evaluation based on a difference between the optical information and a criterion being above or below a numerical value or range of an acceptable criteria; iii) an evaluation based on a ratio of a value of a characteristic of the melt pool and a value of a criterion; iv) an evaluation based on a ratio of a value of a characteristic of the mushy zone and a value of a criterion; v) an evaluation based on a change in a value of the spectral intensity during additively manufacturing of the build piece; vi) an evaluation of the melt pool having an acceptable temperature range during additively manufacturing of the build piece to prevent any defect condition (i.e. any of the above defects) and any evaluations disclosed form the above disclosed PBF systems and apparatuses.

Method 1200 may also include shielding an optical spectrometer from reflected power of a laser that may generate a laser beam. The shielding may include shielding component 246 that may be coupled to radiator collector 221,321 or structure 328 and configured to prevent damage to the optical spectrometer from reflected power of energy beam source 103,211 such as a laser. Shielding component 246 may include an optical filter; a protective lens; a low-pass filter; UV-transparent material such as a film or a film on a lens; and/or a wall or a barrier material that prevents radiation from penetrating therethrough. Shielding component 246 is configured to reduce or eliminate interference with the functionality of the optical spectrometer.

Because the melt pool includes a mushy zone, the method 1200 may also include obtaining mushy zone information from the region. The mushy zone information includes temperature information, temperature gradient, solidification rate, or shape information. Mushy zone (for example, 710 in FIG. 7) is a result of melting and solidification occurring over a temperature range over a region of material. Therefore, mushy zone 710 is the coexistence of a liquid and a solid of material. The material may include a metal, a metallic powder or other materials. As FIG. 7 illustrates, mushy zone includes larger percentages of solid fraction at lower temperatures and smaller percentages of solid fraction at higher temperatures. In view of this physical phenomena, mushy zone 710 includes vulnerable zone 730 and relaxation zone 740. Vulnerable zone 730 is a zone susceptible to solidification cracking and this could translate into build piece 205 including cracks therein. For example, vulnerable zone 730 may include a solid fraction between 0.90 to 0.99. In order to prevent cracks or thermal tearing in the build piece, liquid in vulnerable zone 730 during solidification is needed. Also, want to prevent large grain size development within the build piece. Therefore, the camera and/or the spectrometer obtains mushy zone information from the mushy zone and a process parameter may be modified based on the obtained mushy zone information in order to prevent cracks and/or large grain size in the build piece. Mushy zone information includes at least temperature information, temperature gradient, solidification rate, shape information, shape or a ratio of a length of the relaxation region and a length of the vulnerable region. The shape or shape information of the mushy zone information includes a depth, a length, a width, a perimeter, an area or a volume. Relaxation zone 740 may include a zone of solidification stress. For example, relaxation zone 740 may range from solid fractions between 0.4 to 0.9.

Method 1200 may also include processing the mushy zone information. A computer or process or a combination of a computer and a process may the mushy zone information from the mushy zone.

Method 1200 may also include wherein the evaluation is further based on the mushy zone information. The evaluation may be any of the disclosed evolutions as stated above and which are based on the above disclosed mushy zone information.

Method 1200 may also include an evaluation including a characteristic of the melt pool. The characteristic of the melt pool may include keyhole information, a dimension, a shape, a temperature or a temperature gradient. The shape and shape information may include a depth, a length, a width, a perimeter, an area or a volume. Keyhole information may include shape of the melt pool, cavity shape and/or size of the melt pool, temperature and temperature gradient of the melt pool, flow such as velocity within the melt pool.

Method 1200 may also include modifying a process parameter of the additive manufacturing based on the defect condition. A process parameter includes at least laser power, hatch spacing, scan speed, a beam profile of the laser beam, a beam size of the laser beam, or a beam shape of the laser beam. Process parameter modification may include, for example, reducing or increasing the hatch spacing, scan speed, a beam profile of the laser beam, a beam size of the laser beam, or a beam shape or the intensity of the energy beam such as the laser beam intensity, adjusting the process parameter to maintain a temperature of the melt pool within an acceptable range during additively manufacturing of the build piece, or adjusting the laser power and at least adjusting the hatch spacing, the scan speed, the beam profile or the beam shape.

Method 1200 may also include determining at least a temperature profile or a physical state of the melt pool or the mushy zone from the spectral profile or the spectral intensity. A camera may obtain thermal radiation from the melt pool and an optical spectrometer may obtain spectral information from the melt pool. A computer or processor or the combination of the computer and processor processing the obtained thermal radiation and the obtained spectral intensity. The obtained thermal radiation and the obtained spectral intensity were obtained from a surface of the melt pool during additively manufacturing build piece 109. The approximate surface temperature of the melt pool can be determined by the decomposition of the obtained spectral intensity and superimposing the obtained spectral intensity on obtained and processed broad temperature emissions (i.e., thermal radiation) from a surface of the melt pool. The presence and relative amounts of metal or other elements can be detected by the optical intensity/spectroscopy of the optical spectrometer. The processed spectral information may be a change in a value of the spectral intensity during additively manufacturing of the build piece or may be the spectral intensity of hydrogen, water vapor spectral intensity or a magnesium spectral intensity. These spectral intensities can be directly related to the presence of moisture and hydrocarbon contaminants. For example, a defect condition is a larger spectral intensity presence of H (Hydrogen spectral intensity) found than would be found during normal additively manufacturing operation conditions. An increase in hydrogen will lead to an increase in gas pore defects. This defect condition was determined based on an evaluation of the obtained processed spectral intensity compared to normal operation conditions of additively manufacturing build piece 109. The presence and relative amounts of metal or other elements can be detected by a spectral profile (i.e., spectral intensity distribution over a region of powder such as melted powder in the melt pool or mushy zone) or the optical intensity/spectroscopy of the optical spectrometer or by optical information from the optical camera. The processor or the computer is configured or further configured to determine at least a temperature profile or a state of the mushy zone from the spectral profile or the spectral intensity.

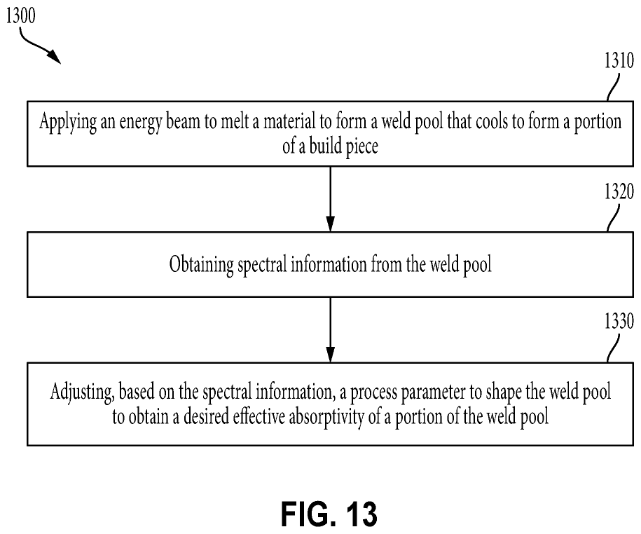

Referring to FIG. 13, a flow chart illustrates an example method 1300 of manufacturing. Method 1300 may be performed with any of the disclosed PBF systems and apparatuses, such as PBF system 100 and PBF apparatus 200. Method 1300 may include applying an energy beam to melt a material to form a melt pool that cools to form a portion of a build piece. (1310) This feature is the same as feature 1210 in FIG. 12 described above.

Method 1300 may include obtaining spectral information from the melt pool (1320), which is similar to feature 1220 in FIG. 12 described above and because the melt pool is within the region, all features described above related to the region may apply to the melt pool.

Method 1300 may include adjusting, based on the spectral information, a process parameter to shape the weld pool to obtain a desired effective absorptivity of a portion of the weld pool, e.g., to increase the effective absorptivity relative to an absorptivity of a surface of the powder or material deposited by the depositor. (1330) Actively controlled monitoring can improve the additively manufacturing overall process energy (electrical power) efficiency. This may be performed by operating the lasing process (e.g., apply the energy/laser beam to the surface of the powder and melting the powder) in the early stage of keyholing. During the early stage of keyholing the effective absorptivity significantly increases from the typical surface absorptivity of the powder material. A greater number of lasing photons are allowed to be absorbed in the wall of the shallow keyhole well. Effective absorptivity for Aluminum in keyholing mode may be increased from 0.15 to 0.70, an increase of 460%. Laser and process parameters can be actively controlled to stabilize and maintain this efficient melt pool state or condition. As illustrated in FIG. 8 and from any of the above disclosed PBF systems and apparatuses, powder 817 may be melted with energy beam 827 and the melted powder forms keyhole melt pool 820. The melt pool is continuously monitored via the camera and/or spectrometer during additively manufacturing build piece 205 to indirectly determine the state of the liquid melt and elemental transitions to vapor. It is noted the vaporization temperature for aluminum is approximately 2300 C at 1 barr. Keyhole melt pool 820 has a shape that is round and large on a top surface and has a thin/narrow shaped spike at a bottom surface. This keyhole melt pool 820 shape resembles a keyhole in a warded lock. Thus, the term keyhole may be derived from this type of lock. Powder melting in a keyhole mode may lead to defects in the build piece. However, the disclosure prevents defects within the build piece by maintaining melt pool 821 within an acceptable temperature range and/or shape by adjusting a process parameter. For example, forming the shape of melt pool 821 having cavity 830 prevents keyhole melt pool 820 and thus prevents defects within the build piece Thus, a determination of a defect condition may be based on an evaluation of a characteristic of the melt pool. The characteristic of the melt pool includes at least keyhole information, a dimension, a shape, a temperature or a temperature gradient. The shape includes a depth, a length, a width, a perimeter, an area or a volume of the melt pool. Keyhole information may include shape of the melt pool, cavity shape and/or size of the melt pool, temperature and temperature gradient of the melt pool, flow such as velocity within the melt pool. Also, to avoid keyholing and associated large diameter spherical voids, the optical spectrometer may be used to detect spectral information. (e.g., spectral intensity and the presence of photon emissions related to electron transitions).

Method 1300 may include depositing a material such as powder by a depositor onto a build plate such that a powder bed forms on the build plate and a build piece is formed within the powder bed by an energy beam melting the power.

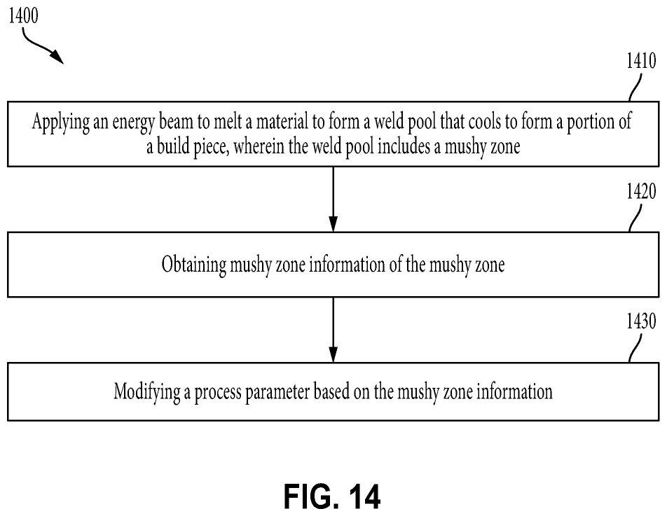

Referring to FIG. 14, a flow chart illustrates an example method 1400 of manufacturing. Method 1400 may be performed with any of the disclosed PBF systems and apparatuses, such as PBF system 100 and PBF apparatus 200. Method 1400 may include applying an energy beam to melt a material to form a melt pool that cools to form a portion of a build piece, wherein the melt pool includes a mushy zone. (1410) This feature is similar to features 1210 and 1310 in FIGS. 12 and 13 and described above. Because the melt pool includes a mushy zone because the melt pool is within the region, all features described above related to the region may apply to the mushy zone.

Method 1400 may include obtaining mushy zone information of the mushy zone (1420) and may include processing the mushy zone information (1430). A camera and/or the spectrometer may obtain mushy zone information from the mushy zone and a process parameter may be modified based on the obtained mushy zone information in order to prevent cracks and/or large grain size in the build piece. Mushy zone information includes at least temperature information, temperature gradient, solidification rate, shape information, shape or a ratio of a length of the relaxation region and a length of the vulnerable region. The shape or shape information of the mushy zone information includes a depth, a length, a width, a perimeter, an area or a volume. A computer or process or a combination of a computer and a process may the mushy zone information from the mushy zone.

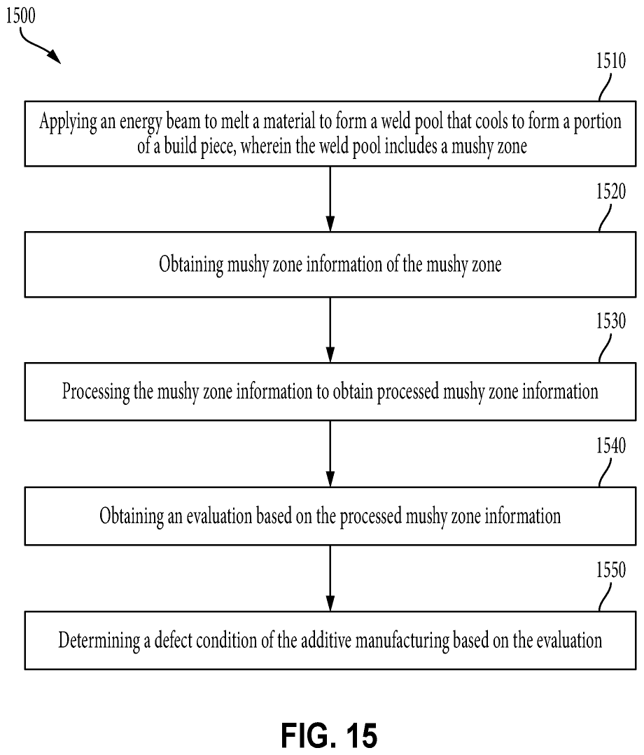

Referring to FIG. 15, a flow chart illustrates an example method 1400 of manufacturing. Method 1500 may be performed with any of the disclosed PBF systems and apparatuses, such as PBF system 100 and PBF apparatus 200. Method 1500 may include applying an energy beam to melt a material to form a melt pool that cools to form a portion of a build piece, wherein the melt pool includes a mushy zone; (1510) obtaining mushy zone information of the mushy zone; (1520) and processing the mushy zone information to obtain processed mushy zone information (1530). These features are similar to the features of 1410,1420 and 1420, which were described above.

Method 1500 may include obtaining an evaluation based on the processed mushy zone information. (1540) A camera and/or the spectrometer may obtain mushy zone information from the mushy zone and a process parameter may be modified based on the obtained mushy zone information in order to prevent cracks and/or large grain size in the build piece. Mushy zone information includes at least temperature information, temperature gradient, solidification rate, shape information, shape or a ratio of a length of the relaxation region and a length of the vulnerable region. The shape or shape information of the mushy zone information includes a depth, a length, a width, a perimeter, an area or a volume. A computer or process or a combination of a computer and a process may the mushy zone information from the mushy zone.

An evaluation may use processor 152, computer 150 or a combination of the processor and computer to compare obtained and processed spectral and processed information with a value; criterion; criteria; data such as historical data from previously additive manufacturing processes; and/or data from the above defect conditions. For example, an evaluation may include: i) an evaluation based on a difference between the spectral information and a criterion being above or below a numerical value or range of an acceptable criteria; ii) an evaluation based on a difference between the optical information and a criterion being above or below a numerical value or range of an acceptable criteria; iii) an evaluation based on a ratio of a value of a characteristic of the melt pool and a value of a criterion; iv) an evaluation based on a ratio of a value of a characteristic of the mushy zone and a value of a criterion; v) an evaluation based on a change in a value of the spectral intensity during additively manufacturing of the build piece; and vi) an evaluation of the melt pool having an acceptable temperature range during additively manufacturing of the build piece to prevent any defect condition (i.e. any of the above defects).

Method 1500 may include determining a defect condition of the additive manufacturing based on the evaluation. (1550) A defect condition of the additive manufacturing process (i.e., additively manufacturing the build piece) may include: i) a defect in the build piece such as porosity (keyholing, lack of fusion etc.), larger pores, interlaminar weld cracks, microstructure changes, increased residual stress, elemental composition variation, material property changes, or other defect types; ii) a condition that might later lead to a defect in the build piece (e.g., an erred subsequent layer, where the layer is too large or small in width, height or depth, the layer has large or small deviations (i.e., undulations) in the surface; defect in the laser beam, process parameter (e.g., incorrect shape, profile or spot size, incorrect power to energy applicator, etc.); iii) defect in the powder bed (e.g., too thick or thin, contains grooves and/or undulations in a layer or layers of the powder bed) and any evaluations disclosed form the above disclosed PBF systems and apparatuses. Also, defects may include increased build time and material costs due to sub-optimal additively manufacturing conditions.

It is noted that the aforementioned operations are provided as examples. While some specific examples are given, one having ordinary skill in the art would understand that additional possibilities of automated, semi-automated, or manual control of the systems and devices of the disclosed support system formation and removal methods and apparatuses described herein would fall within the scope of this disclosure after understanding the disclosure provided herein.

In addition, aspects of the present disclosures may be implemented using hardware, software, or a combination thereof and may be implemented in one or more computers or computer systems, processors or other processing systems. In an aspect of the present disclosures, features are directed toward one or more computers, processors or computer systems capable of carrying out the functionality described herein.

Computer programs (also referred to as computer control logic) may be stored in memory 154 and/or secondary memory. Such computer programs, when executed, enable the PBF systems to perform the features in accordance with aspects of the present disclosures, as discussed herein. In particular, the computer programs, when executed, enable processor 152 to perform the features in accordance with aspects of the present disclosures.

In an aspect of the present disclosures where the method is implemented using software, the software may be stored in a computer program product and loaded into a computer 150 using a removable storage drive, a hard drive, or interface(s). The control logic (software), when executed by a processor, causes the processor to perform the functions described herein. In some examples, the computer 150 may include one or more PBF controller(s), e.g., for controlling any one or combination of the PBF systems described above. In another aspect of the present disclosures, the systems are implemented primarily in hardware using, for example, hardware components, such as application specific integrated circuits (ASICs). Implementation of the hardware state machine so as to perform the functions described herein will be apparent to persons skilled in the relevant art(s).

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub-combinations in one or more embodiments or examples.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

The terms powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). Still other PBF processes to which the principles of this disclosure are pertinent include those that are currently contemplated or under commercial development. The aspects of the disclosure may additionally be relevant to non-metal additive manufacturing and or metal/adhesive additive manufacturing (e.g., binder jetting), which may forgo an energy beam source and instead apply an adhesive or other bonding agent to form each layer. In the case of binder jetting, the cured or green form may be sintered or fused in a furnace and/or be infiltrated with bronze or other alloys.

The detailed description set forth above in connection with the appended drawings is intended to provide a description of various example embodiments of the concepts disclosed herein and is not intended to represent the only embodiments in which the disclosure may be practiced. The terms “exemplary” and “example” used in this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The previous description is provided to enable any person skilled in the art to practice the various aspects described herein. Various modifications to these example embodiments presented throughout this disclosure will be readily apparent to those skilled in the art. Thus, the claims are not intended to be limited to the example embodiments presented throughout the disclosure, but are to be accorded the full scope consistent with the language claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method for additive manufacturing comprising:
applying an energy beam to melt a region of material to form a weld pool that cools to form a portion of a build piece;
obtaining spectral information from the region;
processing the spectral information to obtain processed spectral information;
obtaining an evaluation based on the processed spectral information; and
determining a defect condition of the additive manufacturing based on the evaluation.

2. The method of claim 1, further comprising:
depositing the material onto a build plate, wherein the material includes a powder.

3. The method of claim 1, further comprising:
obtaining optical information from the region; and
processing the optical information to obtain processed optical information,
wherein the evaluation is further based on the processed optical information.

4. The method of claim 3, wherein obtaining the optical information includes controlling a camera to perform optical imaging at a first port with a first field of view of the region of the material, and
obtaining the spectral information includes controlling an optical spectrometer to perform optical spectroscopy at a second port with a second field of view of the region of the material.

5. The method of claim 4, wherein the first field of view and the second field of view are the same.

6. The method of claim 3, wherein obtaining the spectral information includes receiving a backscattered radiation from the region.

7. The method of claim 6, wherein obtaining the spectral information further includes filtering the backscattered radiation to obtain filtered backscattered radiation.

8. The method of claim 4, wherein the energy beam includes a laser beam, and the method further comprising:
shielding the optical spectrometer from reflected power of a laser.

9. The method of claim 6, wherein the weld pool includes a mushy zone, and the method
further comprising:
obtaining mushy zone information from the region; and
processing the mushy zone information,
wherein the evaluation is further based on the mushy zone information.

10. The method of claim 9, wherein the mushy zone information includes at least temperature information, temperature gradient, solidification rate, or shape information.

11. The method of claim 9, wherein the mushy zone includes a relaxation region and a vulnerable region, and
wherein the mushy zone information includes a ratio of a length of the relaxation region and a length of the vulnerable region.

12. The method of claim 3, wherein the evaluation includes a characteristic of the weld pool.

13. The method of claim 12, wherein the characteristic of the weld pool includes keyhole information.

14. The method of claim 12, wherein the characteristic of the weld pool includes at least a dimension, a shape, a temperature or a temperature gradient.

15. The method of claim 14, wherein the shape includes a depth, a length, a width, a perimeter, an area or a volume.

16. The method of claim 3, further comprising:
modifying a process parameter of the additive manufacturing based on the defect condition.

17. The method of claim 16, wherein the modifying comprising:
adjusting the process parameter to maintain an acceptable temperature of the weld pool during additively manufacturing of the build piece.

18. The method of claim 16, wherein the energy beam includes a laser beam.

19. The method of claim 18, wherein the process parameter includes at least laser power, hatch spacing, scan speed, a beam profile of the laser beam, a beam size of the laser beam, or a beam shape of the laser beam.

20. The method of claim 19, wherein the modifying comprises:
adjusting the laser power and at least adjusting the hatch spacing, the scan speed, the beam profile or the beam shape.

21. The method of claim 1, wherein the spectral information includes at least a spectral profile or spectral intensity.

22. The method of claim 21, wherein the weld pool includes a melt pool and a mushy zone, and the method further comprising:
determining at least a temperature profile or a physical state of the melt pool or the mushy zone from the spectral profile or the spectral intensity.

23. The method of claim 21, wherein the processed spectral information is a change in a value of the spectral intensity during additively manufacturing of the build piece.

24. The method of claim 23, wherein the spectral intensity includes a hydrogen spectral intensity, a water vapor spectral intensity, or a magnesium spectral intensity.

25. The method of claim 1, wherein obtaining the spectral information includes performing optical spectroscopy on backscattered radiation from the region.

26. A method for additively manufacturing comprising:
applying an energy beam to melt a material to form a weld pool that cools to form a portion of a build piece;
obtaining spectral information from the weld pool; and
adjusting, based on the spectral information, a process parameter to shape the weld pool to obtain a desired effective absorptivity of a portion of the weld pool.

27. The method of claim 26, further comprising:
depositing the material onto a build plate, wherein the material includes a powder.

28. The method of claim 26, wherein the energy beam includes a laser, and
wherein the spectral information includes at least intensity of reflected laser light, a depth, a length, a width, a perimeter, an area or a volume.

29. A method for additively manufacturing comprising:
applying an energy beam to melt a material to form a weld pool that cools to form a portion of a build piece, wherein the weld pool includes a mushy zone;
obtaining mushy zone information of the mushy zone; and
modifying a process parameter based on the mushy zone information.

30. A method for additively manufacturing comprising:
applying an energy beam to melt a material to form a weld pool that cools to form a portion of a build piece, wherein the weld pool includes a mushy zone;
obtaining mushy zone information of the mushy zone;
processing the mushy zone information to obtain processed mushy zone information;
obtaining an evaluation based on the processed mushy zone information; and
determining a defect condition of the additive manufacturing based on the evaluation.

31. A three-dimensional (3-D) printer for additively manufacturing comprising:
a depositor configured to deposit material;
an energy beam source configured to generate an energy beam, wherein the energy beam is configured to melt a region of the material to form a weld pool that cools to form a portion of a build piece;
a first device configured to obtain spectral information from the region; and
a processor or a computer in communication with the first device and configured to:
process the spectral information to obtain processed spectral information,
perform an evaluation based on the processed spectral information, and
determine a defect condition of the additive manufacturing based on the evaluation.

32. The printer of claim 31, wherein the depositor is configured to deposit the material onto a build plate, wherein the material includes a powder, and the printer further comprising:
a deflector configured to apply the energy beam to the region of the material.

33. The printer of claim 31, further comprising:
a second device configured to obtain optical information from the region,
wherein the processor or the computer is further configured to process the optical information to obtain processed optical information, and
wherein the evaluation is further based on the processed optical information.

34. The printer of claim 33, wherein the spectral information includes a backscattered radiation received from the region.

35. The printer of claim 34, further comprising:
a filter configured to filter the backscattered radiation to obtain filtered backscattered radiation.

36. The printer of claim 33, wherein the first device includes an optical spectrometer and the second device includes a camera.

37. The printer of claim 36, wherein the camera is coupled to a first port of the printer and the optical spectrometer is coupled to a second port of the printer.

38. The printer of claim 36, wherein the optical spectrometer and the camera are coupled to a structure.

39. The printer of claim 38, wherein the energy beam source includes a laser, and the printer further comprising:
a shielding component coupled to the structure and configured relative to the optical spectrometer and the laser to prevent damage to the optical spectrometer from reflected power of the laser.

40. The printer of claim 36, wherein the camera is coupled to a first port of an apparatus and the optical spectrometer is coupled to a second port of the apparatus.

41. The printer of claim 40, wherein the apparatus is coupled to the printer, and
wherein the apparatus is a housing or an optical instrument.

42. The printer of claim 33, wherein the weld pool includes a mushy zone, and
wherein the optical information includes mushy zone information of the mushy zone.

43. The printer of claim 42, wherein the mushy zone information includes at least temperature information, temperature gradient, solidification rate, or shape information.

44. The printer of claim 42, wherein the mushy zone includes a relaxation region and a vulnerable region, and
wherein the mushy zone information includes a ratio of a length of the relaxation region and a length of the vulnerable region.

45. The printer of claim 31, wherein the evaluation includes a characteristic of the weld pool.

46. The printer of claim 45, wherein the characteristic of the weld pool includes keyhole information.

47. The printer of claim 45, wherein the characteristic includes at least a dimension, a shape, a temperature or a temperature gradient.

48. The printer of claim 47, wherein the shape includes a depth, a length, a width, a perimeter, an area or a volume.

49. The printer of claim 31, further comprising:
a controller configured to modify a process parameter based on the evaluation.

50. The printer of claim 49, wherein the controller is further configured to modify the process parameter such that an acceptable temperature of the weld pool is maintained during additively manufacturing of the build piece.

51. The printer of claim 49, wherein the energy beam source includes a laser, and wherein the energy beam is a laser beam.

52. The printer of claim 51, wherein the process parameter includes at least laser power, hatch spacing, scan speed, a beam profile of the laser beam, a beam size of the laser beam, a beam shape of the laser beam or any combination thereof.

53. The printer of claim 31, wherein the spectral information includes at least a spectral profile or spectral intensity.

54. The printer of claim 53, wherein the weld pool includes a mushy zone, and
wherein the processor or the computer is further configured to determine at least a temperature profile or a state of the mushy zone from the spectral profile or the spectral intensity.

55. The printer of claim 53, wherein the processed spectral information is a change in a value of the spectral intensity during additively manufacturing of the build piece.

56. The printer of claim 55, wherein the spectral intensity includes a hydrogen spectral intensity, a water vapor spectral intensity, or a magnesium spectral intensity.

57. A three-dimensional (3-D) printer for additively manufacturing comprising:
a depositor configured to deposit material;
an energy beam source configured to generate an energy beam, wherein the energy beam is configured to melt a region of the material to form a weld pool that cools to form a portion of a build piece;
a first device configured to obtain spectral information from the region; and
a controller configured to adjust, based on the spectral information, a process parameter to shape the weld pool to obtain a desired effective absorptivity of a portion of the weld pool.

58. The printer of claim 57, wherein the energy beam includes a laser, and
wherein the spectral information includes at least intensity of reflected laser light, a depth, a length, a width, a perimeter, an area or a volume.

59. The printer of claim 58, wherein the depth, the length, the width, the perimeter, the area or the volume are of the weld pool.

60. A three-dimensional (3-D) printer for additively manufacturing comprising:
a depositor configured to deposit material;
an energy beam source configured to generate an energy beam, wherein the energy beam is configured to melt a region of the material to form a weld pool that cools to form a portion of a build piece;
a first device configured to obtain information of the weld pool; and
a controller configured to modify, based on the information, a process parameter to maintain an acceptable temperature of the weld pool during additively manufacturing of a build piece.

61. A three-dimensional (3-D) printer for additively manufacturing comprising:
a depositor configured to deposit material;
an energy beam source configured to generate an energy beam, wherein the energy beam is configured to melt a region of the material to form a weld pool that cools to form a portion of a build piece, wherein the weld pool includes a mushy zone;
a first device configured to obtain mushy zone information from the mushy zone; and
a controller configured to modify a process parameter based on the mushy zone information.

62. A three-dimensional (3-D) printer for additively manufacturing comprising:
a depositor configured to deposit material;
an energy beam source configured to generate an energy beam, wherein the energy beam is configured to melt a region of the material to form a weld pool that cools to form a portion of a build piece, wherein the weld pool includes a mushy zone;
a first device configured to obtain mushy zone information from the mushy zone; and
a processor or a computer in communication with the first device and configured to:
process the mushy zone information to obtain processed mushy zone information,
perform an evaluation based on the processed mushy zone information, and
determine a defect condition of the additive manufacturing based on the evaluation.
